(19) United States
(12) Patent Application Publication
(10) Pub. No.: US 2025/0275527 A1
(43) Pub. Date: Sep. 4, 2025

(54) NUISANCE ANIMAL TRAP

(71) Applicants: Jack J. Kennamer, Maineville, OH (US); Pierce M. Kennamer, Boca Raton, FL (US)

(72) Inventors: Jack J. Kennamer, Maineville, OH (US); Pierce M. Kennamer, Boca Raton, FL (US)

(21) Appl. No.: 19/068,073

(22) Filed: Mar. 3, 2025

Related U.S. Application Data
(60) Provisional application No. 63/560,948, filed on Mar. 4, 2024.

(51) Int. Cl. A01M 23/08

(52) U.S. Cl. CPC A01M 23/08

(57) ABSTRACT

A trap catches multiple animals and/or other nuisance animals in one setting. The trap may include a larger confinement volume having a one-way entry door on at least one side and in other embodiments on all sides that remain active no matter how many animals are in the trap. The entry door is designed such that once the animal has started through the door it cannot turn back. Access to remove the animals is also provided. A large bait station that can hold several days of bait and be easily rebaited with minimal contact with the trap is also provided. An inner trap may be contained within the outer trap to the bait for the target animals trapped in the outer trap.

### BACKGROUND OF THE INVENTION

This is claims priority to U.S. Provisional Patent Application Ser. No. 63/560,948, filed Mar. 4, 2024 and is related to U.S. Provisional Patent Application Ser. No. 63/332,717, filed Apr. 20, 2022, and U.S. Utility patent application Ser. No. 18/131,152, filed Apr. 5, 2023. Each of these prior applications is hereby incorporated by reference in its entirety.

This invention relates generally to animal traps, and more specifically, to an animal trap designed to capture iguanas, pythons and other nuisance species.

Pythons are a nuisance in many areas, including Florida because they threaten native wildlife and ecosystems. They are one of the most destructive invasive species in the Everglades. Pythons predate many native wildlife species and eat a wide range of wildlife, including mammals, birds, and other reptiles. They can even eat threatened or endangered species. Non-native Burmese pythons have established a breeding population in South Florida and are one of the most concerning invasive species in the area. Pythons compete with native wildlife for food, which includes mammals, birds, and other reptiles. Severe declines in mammal populations throughout Everglades National Park have been linked to Burmese pythons, with the most severe declines in native species having occurred in the remote southernmost regions of the Park where pythons have been established the longest. A 2012 study found that populations of raccoons had declined 99.3 percent, opossums 98.9 percent, and bobcats 87.5 percent since 1997 (Mammal Decline). Marsh rabbits, cottontail rabbits, and foxes effectively disappeared over that time (Marsh Rabbits Mortality). Pythons can reduce populations of native species, which can have cascading effects on other species and populations. Pythons may also prey on pets like cats and dogs. They may also carry invasive parasites that infect native snakes. The Florida Fish and Wildlife Conservation Commission's Python Action Team (PATRIC) and the South Florida Water Management District's Python Elimination Program work together to remove pythons from the wild. Additionally, the public is encouraged to remove and humanely euthanize pythons on private lands with landowner permission.

Hence, there is an ongoing need to have a system and method of controlling pythons and other nuisance species.

### SUMMARY OF THE INVENTION

A system and method for trapping and containing pythons, iquanas and other nuisance species are provided by various embodiments of this invention.

This invention is a trap according to various embodiments and is designed to catch multiple animal's in one setting. The features of the trap in various embodiments include a large box or cage consisting of one-way door(s) or openings on at least one side and in other embodiments all sides that never lock and remain active no matter how many animals are in the trap. An entry door is provided and designed such that once the animal has started through the door it cannot turn back. Access to remove the animals is also provided. A large bait station that can hold several days of bait/food and be easily rebaited while minimal contact with the trap is also provided.

In various embodiments, this invention is directed to a trap for a target animal such as a python and utilizes first and second traps, one contained within the other. The inner trap may include bait for mice and rodents which are to be used as bait animals. Once the rats or mice as bait animals are in the inner trap, the pythons are attracted to the inner trap and enter the outer trap via a one-way door. Once in the outer trap, the pythons cannot exit the outer trap nor access the bait animals in the inner trap.

The trap in various embodiments may be designed to be easily disassembled for easy transportation and shipping. The trap may have one or more anchor points so it can be securely anchored to prevent the trap from being stolen or blowen away in bad weather such as a hurricane. The access door may have a lock to prevent unauthorized access to the trap and its contents. The trap is designed to operate quietly with no slamming doors or other components that would cause noises that would scare the animals away.

Pythons are an invasive species to the US and are destroying environment and wildlife in south and central Florida. As it turns out, animals such as iquanas are part of the python's diet. A trap full of animals such as iguanas will attract pythons. The design of the trap according to various embodiments of this invention will allow a python to enter in the same fashion as the animal without restriction. Once a python enters the trap, it will be in the same predicament as other animals with no way out. Pythons have now started to move out of the everglades in search of food, such as dogs, cats, rats, racoons, and animals. This invention could have a cover made from canvas or like kind material to be used as camouflage and to conceal/hide the trap from view. In winter months it would hold heat in the trap further attracting the animals in search of warm places when it gets colder outside. The cover can be in a variety of colors or color combinations to best suit the situation/environment.

Other embodiments of this invention include an escape door for non-targeted species, such as fur bearing species, to escape the trap should they become captured. Still further embodiments of this invention include a bait compartment and heating pad to further entice the targeted animals to enter the trap.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings. Like reference numerals are used to indicate like parts throughout the various drawing figures, wherein:

FIG. 1 is a perspective view of one embodiment of the trap according to this invention;

FIG. 2 is a perspective view of the base of the trap of FIG. 1;

FIG. 3 is a perspective view of the side and top walls of the trap of FIG. 1 in a generally planar configuration;

FIG. 3A is a view similar to FIG. 3 with only an access door on the top wall shown;

FIG. 4 is a perspective view of the top and side walls being assembled into an erected configuration;

FIG. 5 is an enlarged perspective view of a corner of the base of the trap being secured to an underlying ground surface;

FIG. 6 is an enlarged perspective view of a portion of the erected side walls being coupled to the base;

FIG. 7 is a side elevational view of the assembled trap according to one embodiment of this invention with bait receptacles shown in phantom lines;

FIG. 8A is an enlarged side elevational view partially in cross-section showing an animal approaching tines of an entry door on the base of the trap;

FIG. 8B is a view similar to FIG. 8A with the animal entering the entry door and deflecting the tines inwardly;

FIG. 8C is a view similar to FIGS. 8A and 8B with the animal trapped in the trap;

FIGS. 9A-9F are alternative embodiments of the tines of the entry door according to various embodiments of this invention;

FIG. 10 is a perspective view of an auxiliary cage according to various embodiments of this invention;

FIG. 10A is a view similar to FIG. 10 showing handles and a trap door on the auxiliary cage;

FIG. 11 is a perspective view of the erected side and top walls being assembled with a base of the auxiliary cage;

FIGS. 12A and 12B are sequential side elevational views partially in cross-section of the auxiliary cage being coupled to the trap according to one embodiment of this invention;

FIG. 13 is a perspective view of the coupled trap and auxiliary cage of FIGS. 12A-12B;

FIG. 14 is a perspective view of an alternative embodiment of the trap according to this invention;

FIG. 15 is an enlarged view of a portion of the trap of FIG. 14;

FIG. 16 is a perspective view a of a further embodiment of this invention including an escape door for non-targeted captured species;

FIG. 17 is a top plan view of the trap of FIG. 16;

FIGS. 18A-18B are sequential enlarged side elevational views of the escape door of FIGS. 16-17;

FIG. 18C is a view similar to FIG. 18A of another embodiment of the escape door;

FIG. 18D is a still further embodiment of the escape door;

FIG. 19A is a front elevational view of one embodiment of the escape door;

FIG. 19B is a view similar to FIG. 19A of a still further embodiment of the escape door;

FIG. 19C is a view similar to FIGS. 19A-19B of a yet further embodiment of the escape door;

FIG. 19D is a view similar to FIGS. 19A-19C of a further again embodiment of the escape door;

FIG. 20 is a perspective view of the trap being positioned on a pad according to one embodiment of this invention;

FIG. 21 is a side elevational view of a rat trap which may be used as a stand-alone trap or in combination with a trap intended for animals or other animals as disclosed herein;

FIG. 22 is an exploded view of a removable trapping/bait box from the embodiment of FIG. 21;

FIG. 23 is a top elevational view of the embodiment of FIG. 21;

FIG. 24 is a side elevational view of a bait cone which may be used in conjunction with the embodiment of FIG. 21;

FIGS. 25A thru 25D are various views of alternative embodiments of the rat trap;

FIG. 26 is a perspective view of a trap within a trap embodiment of this invention;

FIG. 27 is a view similar to FIG. 26 with an outer trap shown in phantom lines to allow for viewing of an inner trap; and

FIG. 28 is a side elevational view of the embodiment of FIGS. 26-27 showing the bait and target animals therein according to one embodiment of this invention.

### DETAILED DESCRIPTION OF THE INVENTION

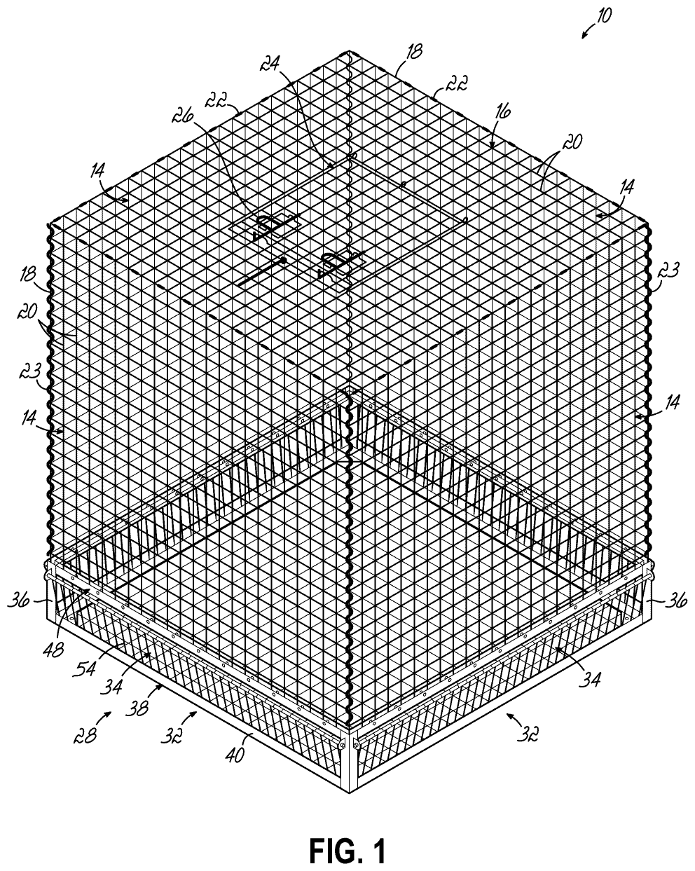

With reference to the drawings, one embodiment of a trap 10 according to this invention is shown in FIG. 1. The trap 10 is described herein for use to trap iguanas or pythons, but one of ordinary skill in the art will appreciate that this invention is not limited to use for such animals only, but is readily applicable for trapping any animal or animals 12. According to the embodiment shown in FIG. 1, the trap 10 has four side walls 14 and a top wall 16, but the trap 10 may be in other configurations according to this invention. Each wall 14, 16 may be constructed of a wire mesh 18 formed of a number of intersecting wires 20. The walls 14, 16 may be of another construction according to this invention.

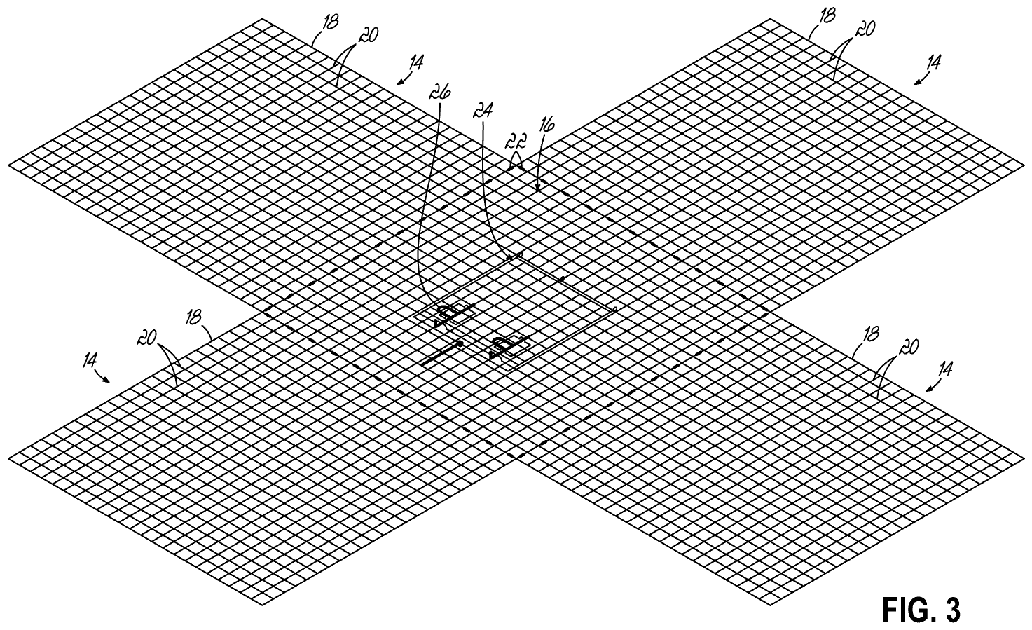

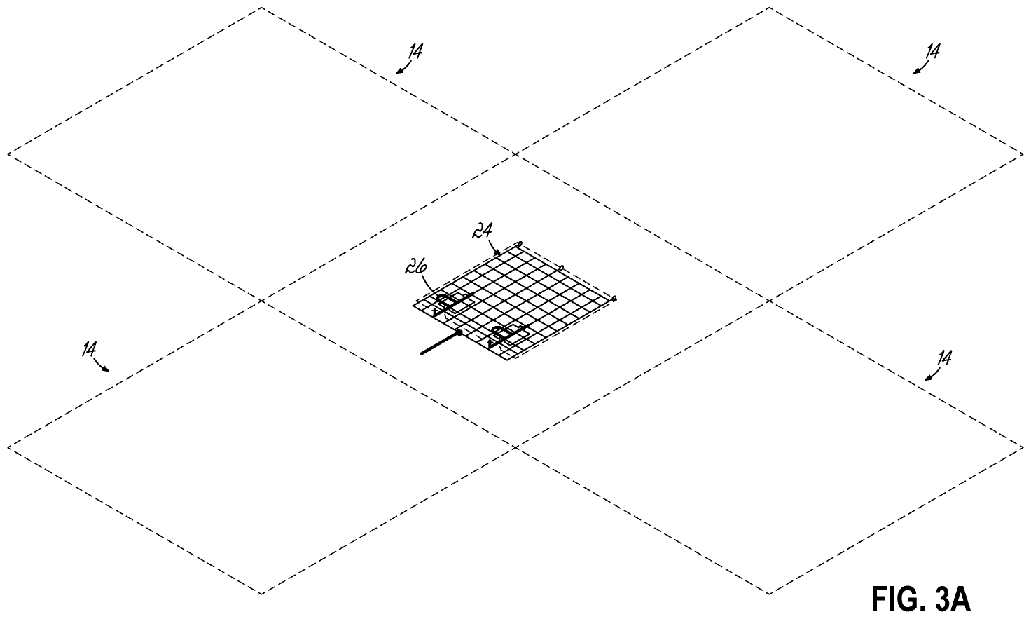

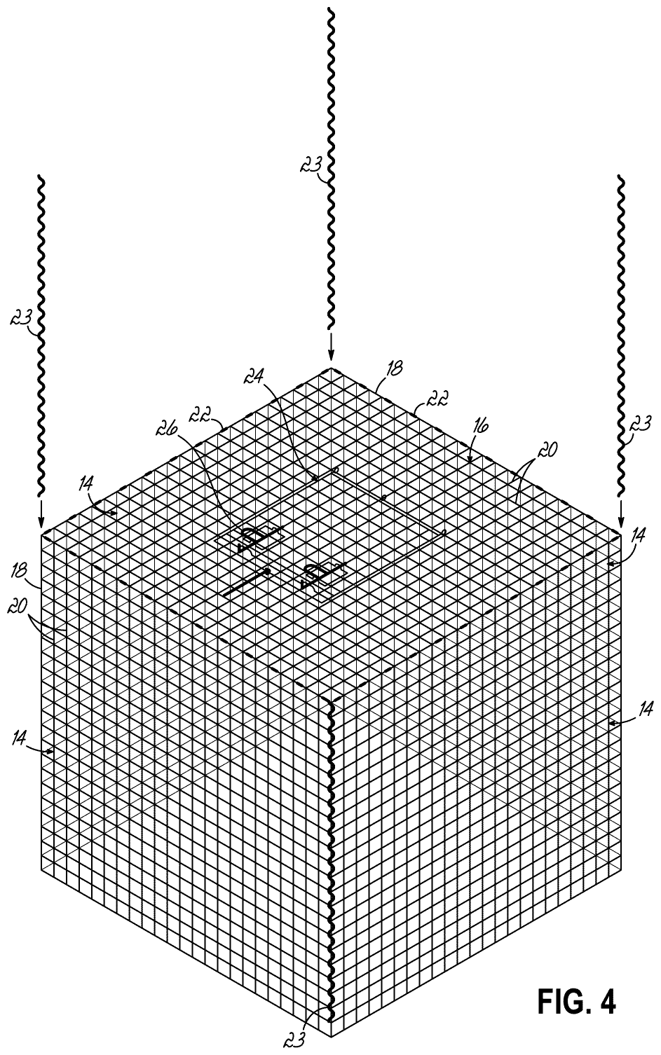

As shown in FIG. 3, each side wall 14, may be pivotally joined to the top wall 16 by a number of clips 22 which join a perimeter edge of each side wall 14 to one of the perimeter edges of the top wall 16 to form a cruciform arrangement. Each side wall 14 may be pivoted downwardly about the associated clips 22 to be generally perpendicular to the top wall 16 and the adjacent side walls 14 as shown in FIG. 4. The adjacent edges of the adjacent side walls 14 may be joined together by twisting, turning, screwing or threading a multi-turn, convolute elongate wire 23 around the perimeter wires of each of the adjacent side walls 14. The top wall 16 is shown with an access door 24 pivotally mounted to the top wall 16 and secured in a closed position by a clasp 26. In alternative embodiments, the trap 10 may be manufactured in one piece with all of the side walls permanently affixed to each other as well as a base 28.

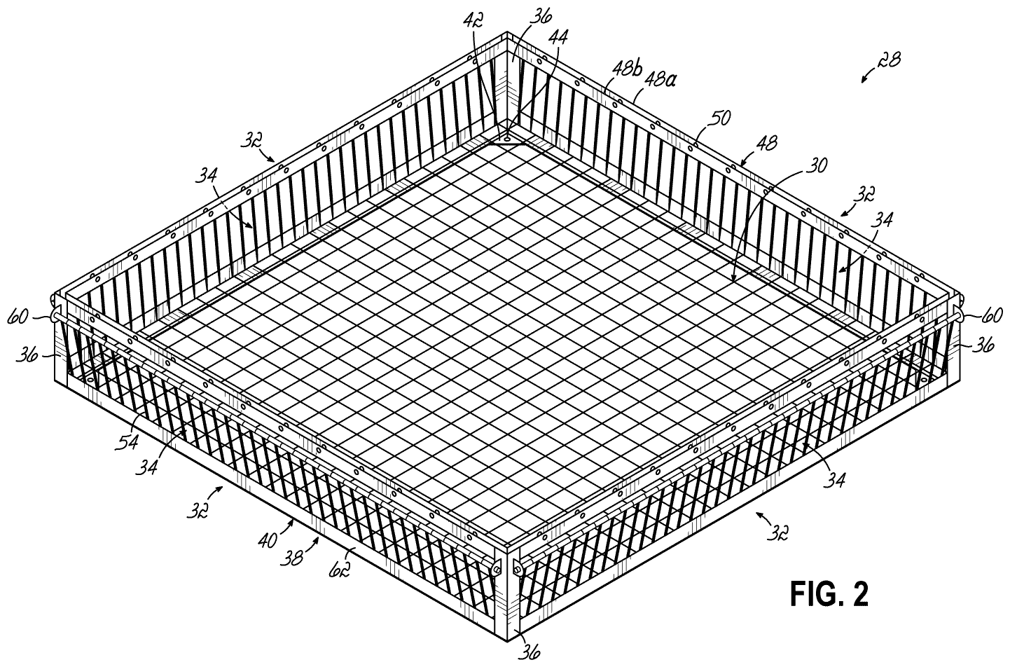

The trap 10 according to various embodiments includes a base 28 as shown in FIG. 2. The base 28 is assembled with the side and top walls 14, 16 to form the trap 10. The base 28 includes a bottom panel or wall 30 which may be mesh or of another configuration. A number of walls 32 extend upwardly from the bottom panel 30 equal in number to the number of side walls 14 on the trap 10. In the embodiment shown in FIGS. 1-2, each wall 32 of the base 28 includes an entry door 34 for the animal 12 to enter the trap 10. Each entry door 34 may extend substantially the full length of the associated wall 32 as shown in FIG. 2.

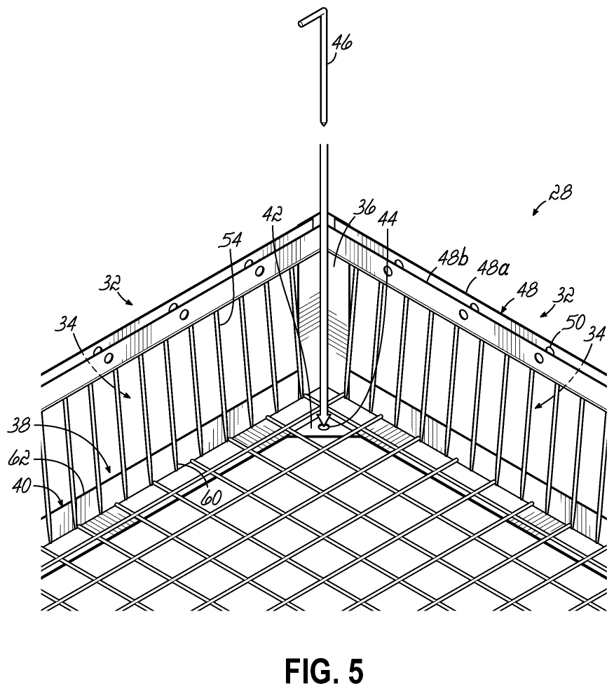

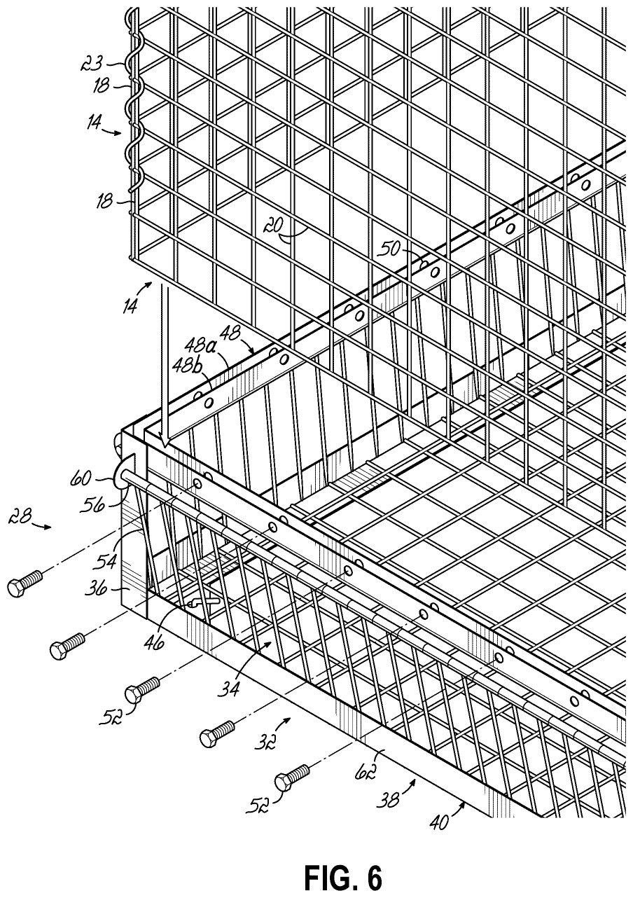

As shown most clearly in FIGS. 2 and 5-6, the base 28 includes corner posts 36 at each juncture between adjacent walls 32. A base frame 38 is formed around the bottom perimeter of the base 28 and each frame member 40 of the base frame 38 may be L-shaped in cross-section. A gusset 42 at each corner of the base frame 38 may have an aperture 44 through which a stake 46 or other anchor post may be inserted to at least temporarily secure the trap 10 to the ground surface there beneath. An upper rim 48 of each wall 32 may have a spaced double wall 48a, 48b construction as shown in FIGS. 5-6. Each rim wall 48a, 48b of the upper rim 48 may have a number of holes 50 therein aligned with a complimentary hole 50 in the adjacent rim wall 48a, 48b .

As seen in FIG. 6, a lower edge of each side wall 14 may be seated on the upper rim 48 between the rim walls 48a, 48b to mate the base 28 with the side walls 14 and top wall 16 of the trap 10. Mechanical fasteners, screws or bolts 52 may be inserted into the aligned holes 50 to secure the side walls 14 to the base 28.

Each entry door 34 may have a number of spaced and downwardly oriented tines 54 suspended from a hub 56 mounted on a rod 58. Each rod 58 is mounted between a pair of end brackets 60 and spaced from the upper rim 48 of the associated base wall 32. Each tine 54 is mounted via its associated hub 56 for pivotal movement about the rod 58. As shown in FIG. 5, each tine 54 has a spike 60 or other end feature at a distal end of the tine 54. The spike or end feature 60 of each tine 54 is juxtaposed to an inner surface of an upstanding leg or detent 62 of the frame member 40 of the base frame 38 such that the tine 54 may only pivot inwardly into an interior of the trap 10. Each tine 54 of each entry door 34 is prevented by the upstanding leg 62 of the frame member 40 from pivoting outwardly beyond the upstanding leg 62. Each tine 54 is biased by gravity to rest against the associated upstanding leg 62 since the rod 58 is positioned outwardly from the upstanding leg 62 as shown in FIGS. 6, 7, 8A and 8C. Alternative embodiments of the trap 10 may include one or more torsion springs biasing the tines 54 outwardly against the upstanding leg 62.

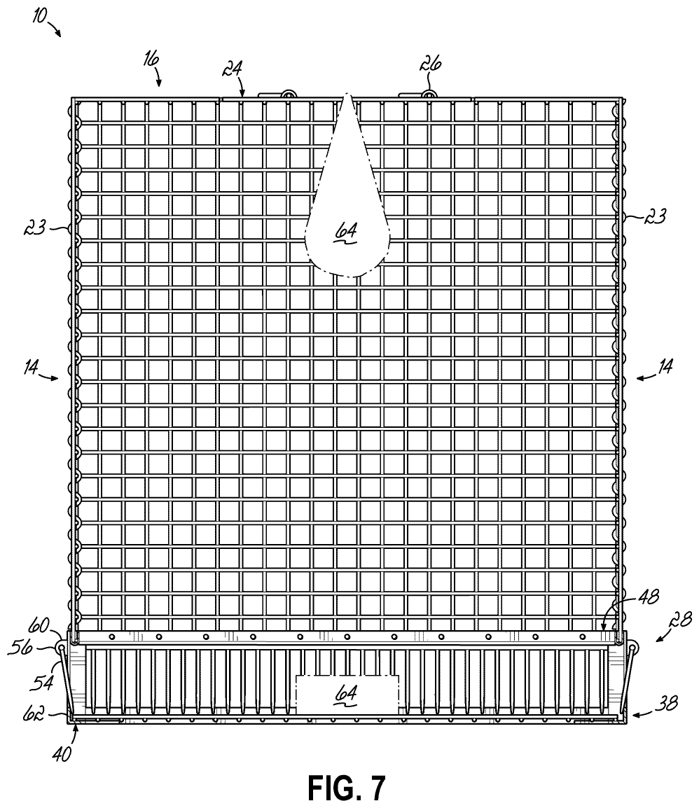

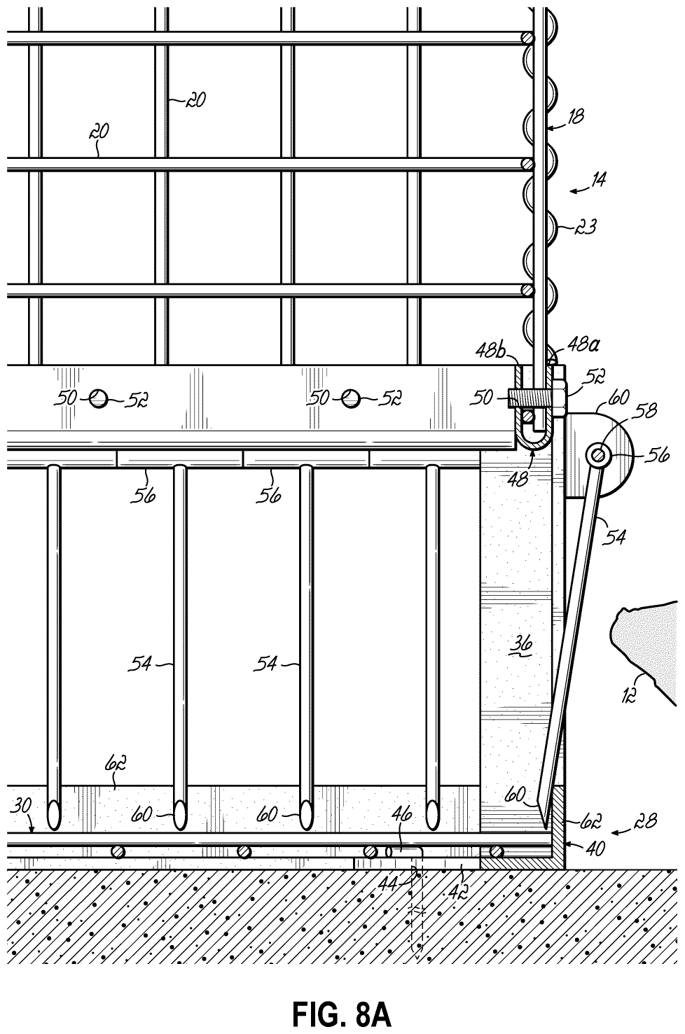

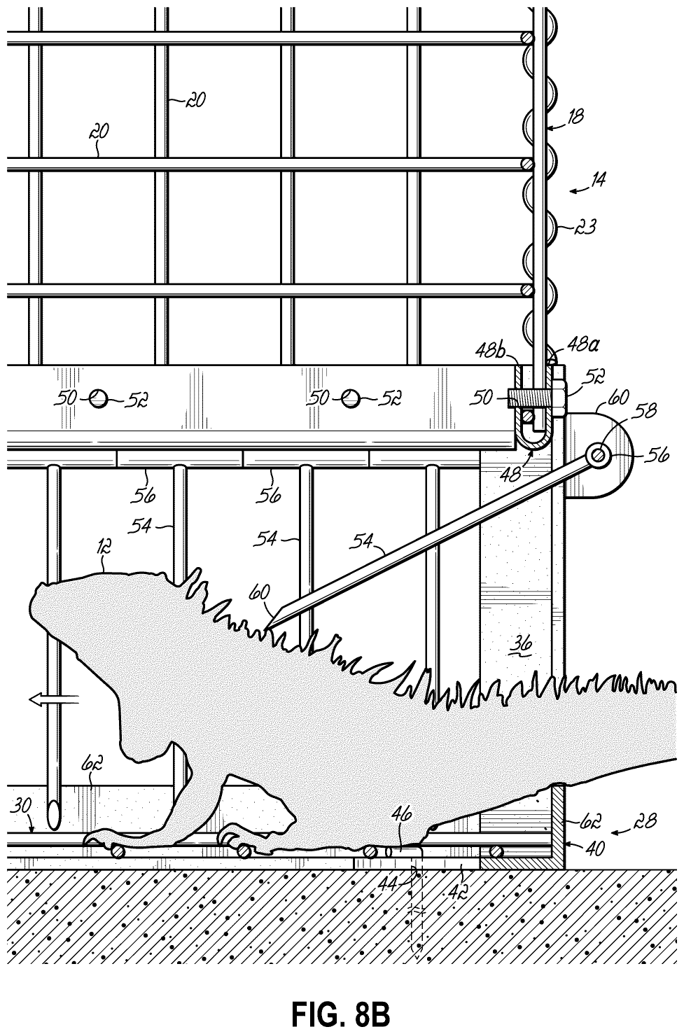

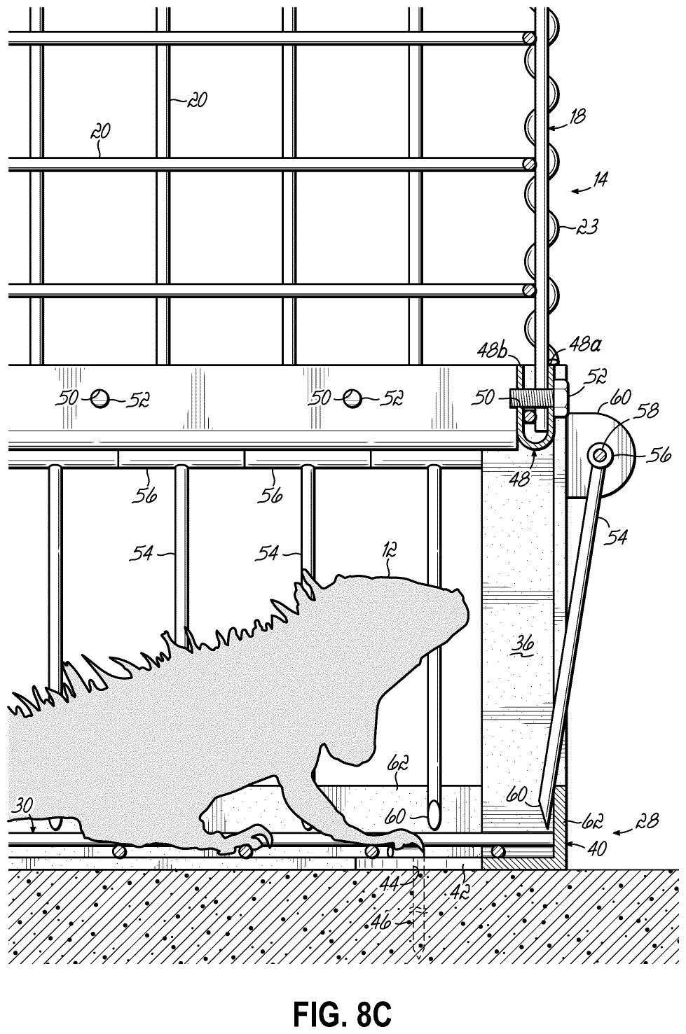

As seen in FIG. 7, one or more bait receptacles 64 may be suspended from the top wall 16 and/or located on the bottom wall 30 to entice the animal 12 to enter the trap 10 via one of the entry doors 34. Referring to FIGS. 8A thru 8C, the animal 12 may approach one of the entry doors 34 in search of the bait 64 within the trap 10 (FIG. 8A). The animal 12 pushes through one or more tines 54 of the entry door 34 thereby pivoting the associated tines 54 inwardly about the rod 58 from which the tines 54 are suspended. The tines 54 offer little resistance to the animal 12 entering the trap 10 in search of the bait 64 (FIG. 8B). Once the animal 12 has entered the trap 10, each inwardly pivoted tine 54 which allowed entry of the animal 12 returns to its rest position by gravity or otherwise against the upstanding leg 62 of the frame member 40 as shown in FIG. 8C. The animal 12 is prevented from escaping the trap 10 by pushing the tines 54 of the entry doors 34 outwardly because the tines 54 are prevented from pivoting outwardly beyond the upstanding leg 62 of the frame member 40. The spacing between the tines 54 is sufficiently small to prevent a trapped animal 12 or other animal from escaping the trap 10 between the tines 54. The hub 56 of each tine 54 is juxtaposed against the adjacent hub 56 of the adjacent tine 54 to prevent lateral movement of the tines 54. Moreover, other animals 12 may also enter the trap 10 via the entry doors 34 in a similar manner even though one or more animals are already trapped in the trap 10. Each tine swings independently so as the animal enters the trap the tines slide/hug along its body, so as they enter the trap they don't create an opening large enough for an animal that is already in the trap to escape.

In alternative embodiments of this invention, a live bait compartment collects live bait that will attract the target animals or reptiles. A full rodent may be within the trap 10. The rodent trap attracts rats or other bait that will be live captured in the bait compartment. Rodents are a favorite food of these reptiles. Rats are also a nuisance pest and plentiful making it an ideal bait. A self-baiting trap may be located deep in any portion of the trap 10 to draw the target bait deep into the trap. No access is provided for the reptiles or non-targets to get to the rodents in the bait compartment to eat them to provide an endless source of live bait for the target animals with the trap 10. Another option is to provide a compartment that could be preloaded with rats for bait according to this invention.

Alternatively, a separate rodent trap that can be easily added to the trap 10 may be a freestanding trap for inner-city use.

In various embodiments of this invention, the tines 54 are constructed to allow non-target animals to escape (racoons, opossums, cats, etc.). Non-target animals may have front paws with much greater dexterity for holding food or other smaller tasks. The animals have large spread out toes more conducive to climbing than for finer dexterity. This unique difference allows non-target animals to grab the tines in ways the animal cannot. Non-target animals may simply grab the tine and pull it up to create an exit. Pythons and other snakes, for example, have no hands, but like animals they push their way into the trap and remain captured as they have no way to open the tines.

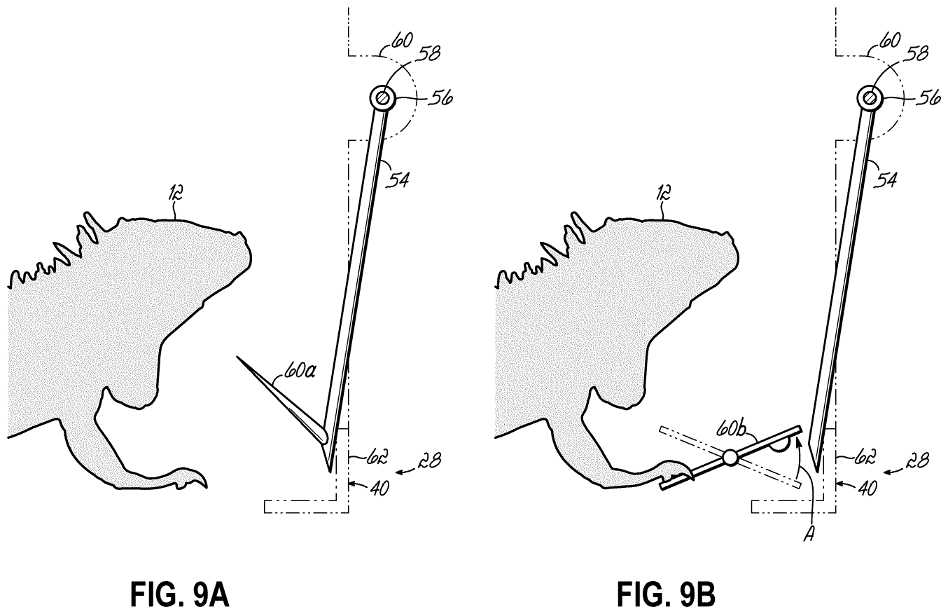

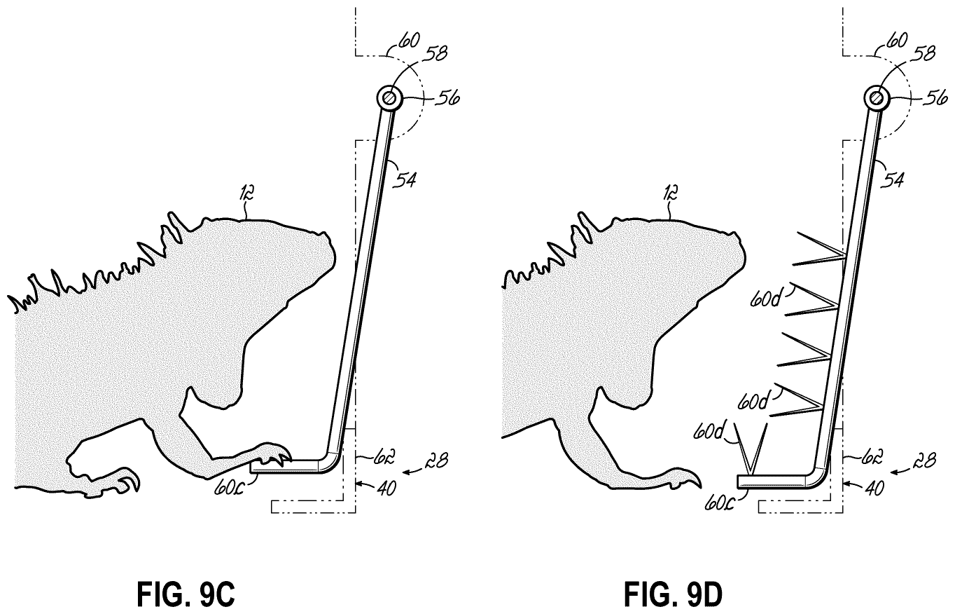

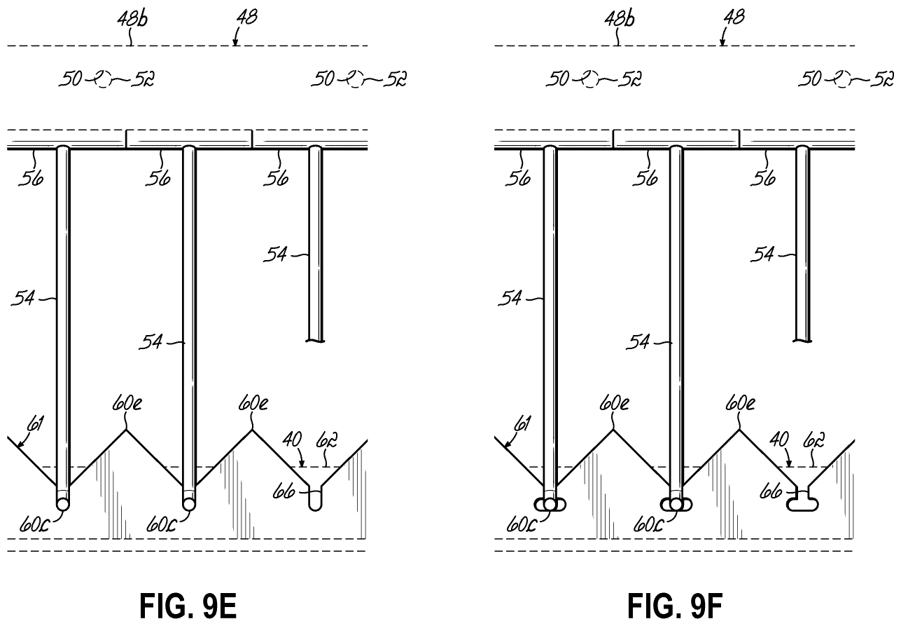

Alternative embodiments of the entry door 34 and/or end feature 60 are shown in FIGS. 9A thru 9F according to this invention. Each tine 54 may have an additional spike 60a projecting into the interior of the trap 10 as shown in FIG. 9A to deter a trapped animal 12 from exiting the trap 10. A pivot plate 60b as in FIG. 9B may be positioned relative to one or more tines 54 to block the associated tine(s) 54 from pivoting inwardly when stepped on by the animal 12 trapped in the trap 10. An end of the pivot plate 60b pivots upwardly in the direction of arrow A to block inwardly movement of the associated tine(s) 54. The end feature 60c of the tine 54 may be an inwardly directed flange 60c such that when the trapped animal 12 steps on the flange 60c, the tine 54 is forced against the upstanding leg 62 to prevent the animal 12 from exiting through the entry door 34. The end feature 60d may be one or more spikes 60d projecting from the flange 60c and/or a shaft of the tine 54.

A barricade 61 may be added to the L-shaped frame member and spaced from the upstanding leg 62 as shown in FIGS. 9E-9F. The barricade 61 may have one or more peaks 60e formed therein with a groove 66 between each peak 60e. The groove 66 may be laterally oriented as shown in FIG. 9F to allow for lateral movement of the tine 54 seated in the groove 66.

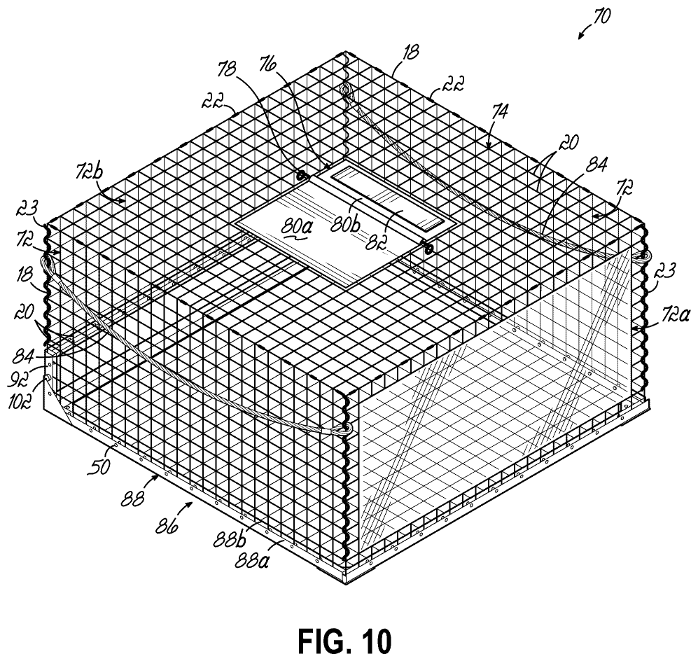

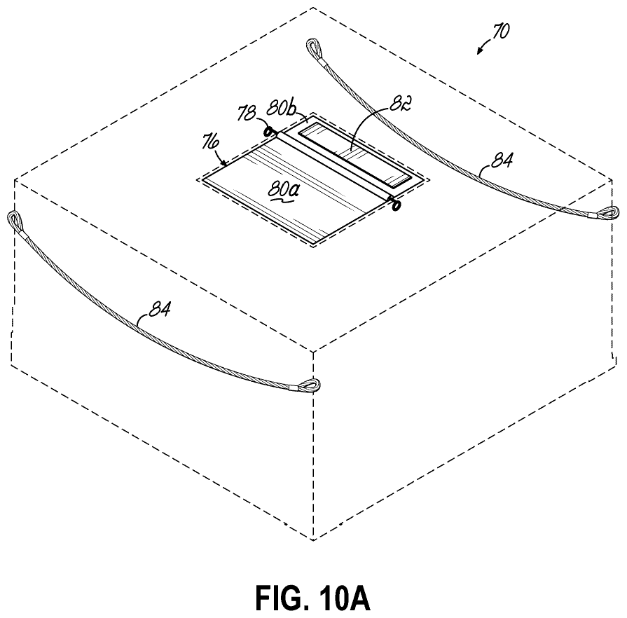

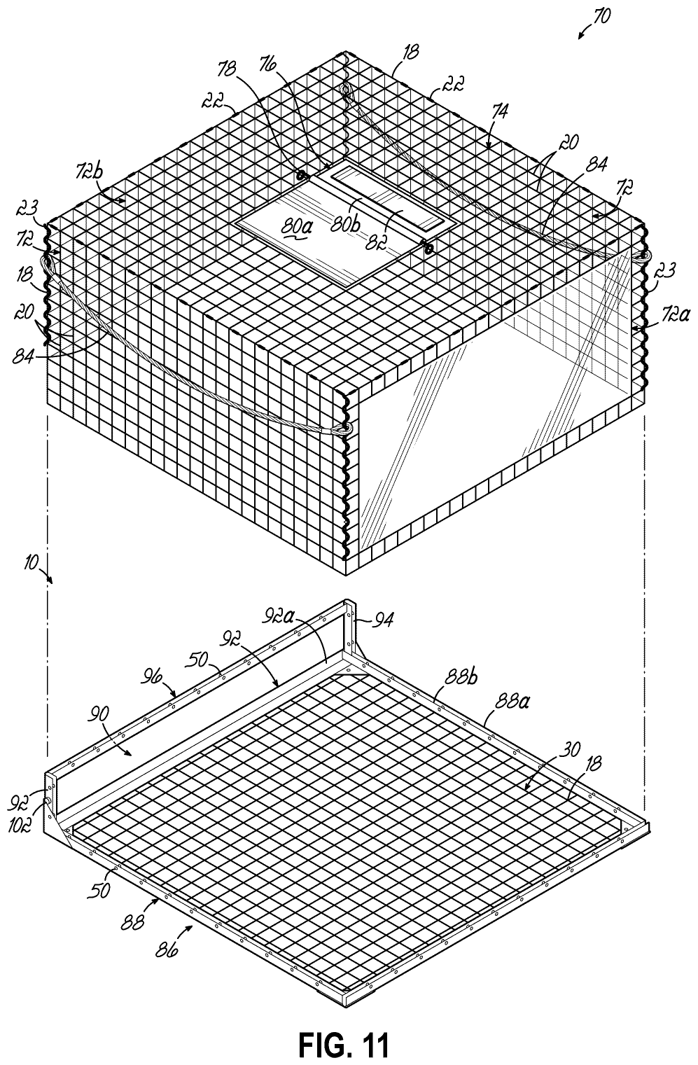

Another aspect of various embodiments of this invention is shown in FIGS. 10-10A in the form of an auxiliary cage 70 which may have four side walls 72 and a top wall 74. Upper edges of the side walls 72 may be joined to perimeter edges of the top wall 74 with clips 22 as in the trap 10. One or more of the side walls 72 may include a mirror 72a to provide a reflection of any animal 12 within the cage 70 or trap 10. The side wall 72b opposite from the mirror 72 may be shorter than the other side walls 72. Adjacent side edges of the side walls 72 may be joined to each other with convolute wires 23 as in the trap 10. The top wall 74 may have a trap door 76 which is mounted on a pivot shaft 78 to divide a trap door wall 80 into major and minor portions 80a, 80b. The minor portion 80b may have a weight 82 to bias the trap door wall 80 into a closed position about the pivot shaft 78. When an animal 12 or other animal steps on the major portion 80a of the trap door wall 80, the mass of the animal 12 or other animal overcomes the mass of the weight 82 and the trap door wall 80 pivots about the pivot shaft 78 with the major portion 80a pivoting downwardly and the animal 12 falling into the auxiliary cage 70. Once the mass of the animal 12 is removed from the major portion 80a of the trap door wall 80, the weight 82 pivots the minor portion 80b downwardly to the closed position shown in FIGS. 10-11. The trap door 76 may be included in the auxiliary cage 70, the trap 10 or both of them in various embodiments of this invention.

The auxiliary cage 70 is easily transported by a user grasping one or both cable handles 84 attached to the side walls 72 and/or top walls 74. The cable handles 84 are located on the exterior of the auxiliary cage 70 so that any animal or other animal 12 within the cage 70 may not damage, weaken or interfere with the cable handles 84. The auxiliary cage 70 includes a base 86 having a wire mesh 18 and a perimeter frame 88. Three sides of the perimeter frame 88 include spaced double wall 88a, 88b construction as shown in FIG. 11. Each rim wall 88a, 88b of the frame 88 may have a number of holes 50 therein aligned with a complimentary hole 50 in the adjacent frame wall 88a, 88b . As seen in FIG. 11, a lower edge of each side wall 72 may be seated on the frame 88 between the walls 88a, 88b to mate the base 86 with the side walls 72 and top wall 74 of the auxiliary cage 70. Mechanical fasteners, screws or bolts 52 may be inserted into the aligned holes 50 to secure the side walls 72 to the base 86.

One side of the base frame 88 may have an entry portal 90. The entry portal 90 is formed by an L-shaped member 92 on the fourth side of the frame 88 having an upstanding leg 92a. Side posts 94 extend upwardly from the frame 88 and a U-shaped upper member 96 extends between the posts 94 and spaced above the L-shaped member 92. Each side post 94 also has a U-shaped cross-section. The spaced walls of the U-shaped members 94, 96 may have a number of holes 50 therein aligned with a complimentary hole 50 in the adjacent member. As seen in FIG. 11, a lower edge of the shorter side wall 72b may be seated on the upper member 96 between the spaced walls to mate the base 86 with the side walls 72 and top wall 74 of the auxiliary cage 70. The lower ends of the side edges of the walls 72 adjacent to the shorter wall 72b may be seated between the walls of the U-shaped side posts 94. Mechanical fasteners, screws or bolts 52 may be inserted into the aligned holes 50 to secure the side walls 72 to the base 86. The posts 94, L-shaped frame member 92 and the upper member 96 define the entry portal 90 of the auxiliary cage 70.

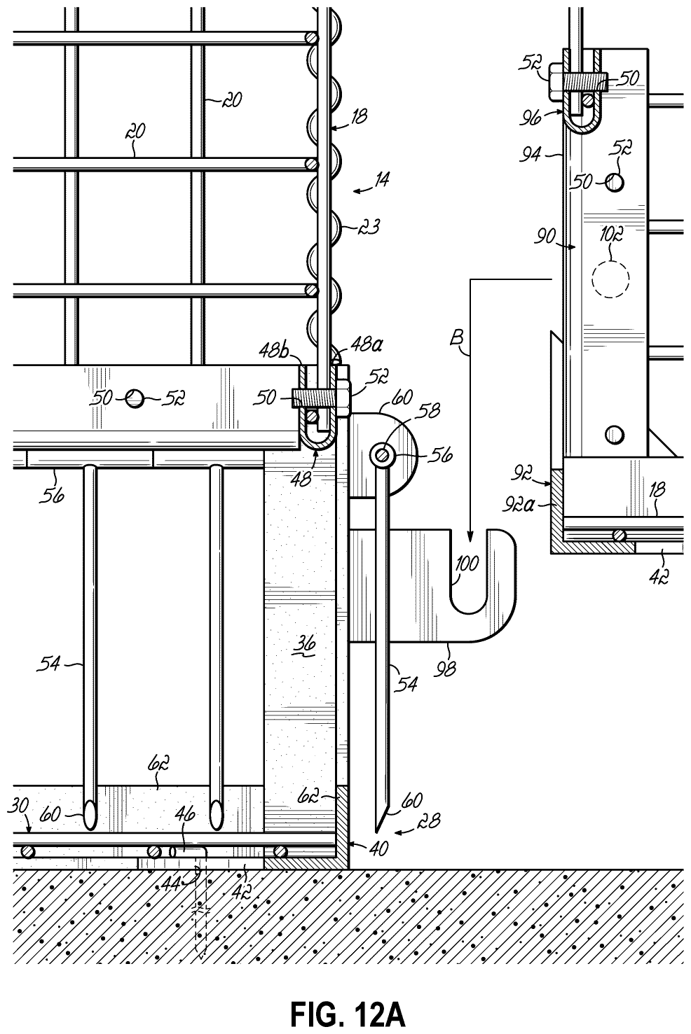

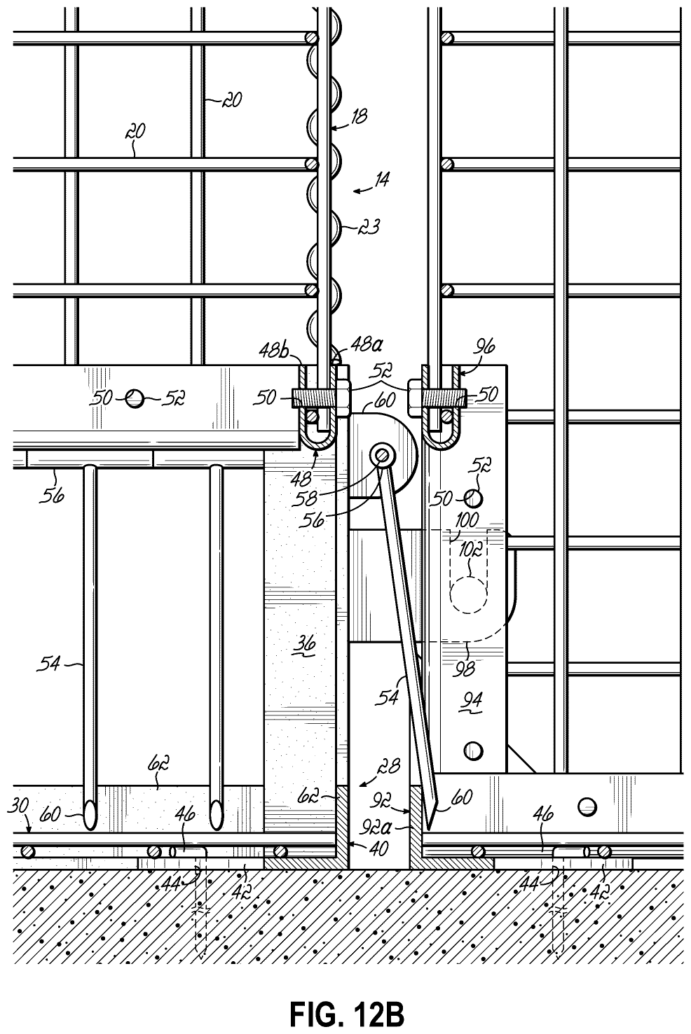

When the trap 10 has one or more animals 12 captured therein, the auxiliary cage 70 may be coupled to the trap 10 of off-load the animals 12 into the cage 70. One or more brackets 98 with an upward U-shaped slot 100 may extend from a common side of the trap 10 as shown in FIG. 12A. The tines 54 of the entry door 34 on the side of the trap 10 with the brackets 98 may be positioned outwardly of the upstanding leg 62 and hang generally vertical from the rod 58. A brace 102 is provided on the posts 94 extending between the walls of the post 94. The cage 70 is coupled to the trap 10 by lowering the cage 70 and positioning the brace 102 to be seated in the U-slot 100 of the bracket 98 as shown by arrow B in FIG. 12A. Alternative embodiments of this invention may have the bracket on the auxiliary cage and the brace on the trap or another attachment system. The tines 54 of the entry door 34 adjacent to the cage 70 and the entry portal 90 are positioned against the upstanding leg 92a of the L-shaped frame member 92 as shown in FIG. 12B. In this arrangement, the cage 70 is coupled to the trap 10 and the entry door 34 is in communication with the entry portal 90 to allow animals 12 in the trap 10 to pass through the entry portal 90 and into the cage 70. The mirror 72a is visible by the animals 12 in the trap 10 and the reflections seen in the mirror 72a entice the animals 12 to pass through the entry door 34 and entry portal 90 to enter the cage 70. The animals 12 in the cage 70 are prevented from exiting the cage 70 via the entry portal 90 by the tines 54 if the trap 10 juxtaposed to the upstanding leg 92a of the cage frame member 92.

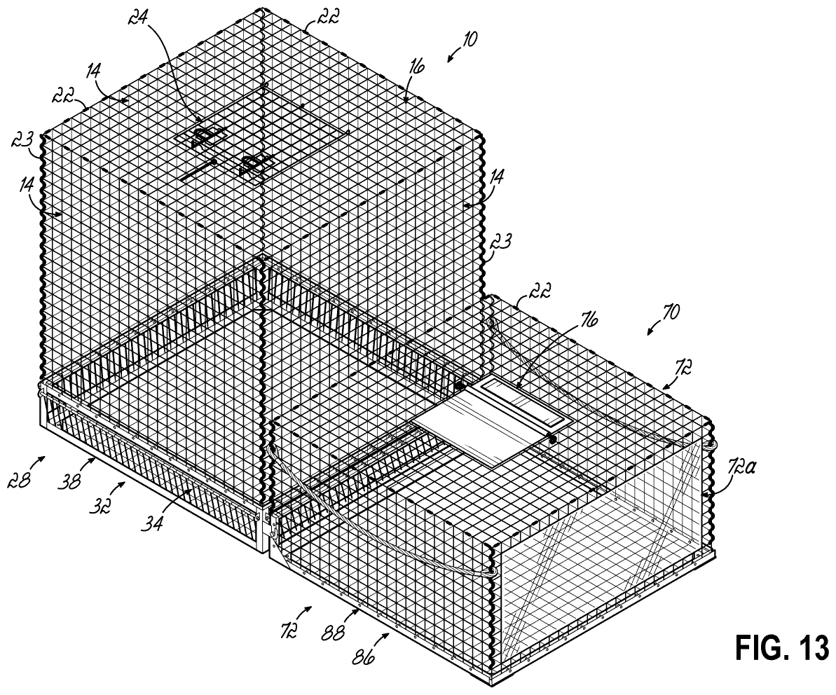

The auxiliary cage 70 mated with the trap 10 is shown in FIG. 13. The animals 12 in the trap 10 may be off-loaded by migration into the cage 70, which may then be decoupled from the trap 10 for relocation of the animals 12 in the cage 70. The off-loading of the animals 12 in the trap 10 is accomplished without moving the trap 10 according to various embodiments of this invention. The entry portal 90 of the cage 70 may be temporarily blocked by bungee cords stretched across the entry portal 90 and hooked to the mesh 18 of the cage 70 or another means while transporting the animals 12 in the cage 70. A gusset 42 at each corner of the base frame 38 may have an aperture 44 through which a stake 46 or other anchor post may be inserted to at least temporarily secure the trap 10 to the ground surface there beneath.

The trap 10 may have any number of entrances and holding chamber entrances. An additional aspect of various embodiments of this invention is that the trap 10 does capture the target species (i.e. animals) but does not retain “non-target species” (i.e., raccoons, possums, cats, etc.). This is likely because the non-target species have paws (hands) that are different from the animal's, and they are able to grab the tines (doors) and open them to escape.

In alternative embodiments of this invention, the auxiliary cage 70 may be connected to the trap 10 with a chute or tunnel that extends from the trap 10 into the auxiliary cage 70. The tunnel or chute may house the tines 54 and provide the alignment for connecting the trap 10 and the auxiliary cage 70. Traps 10 without the auxiliary cage 70 connected thereto will instead have another entrance.

Another aspect of some embodiments is the addition of one or more water bowls and filler bottles the trap 10. This allows for the possibility that the animals could be in the trap for up to a week and although they can survive without any issues, providing water is often considered more humane. The bowls can also collect rain and sprinkler water. When an animal could be in the trap for extended periods (a few days), it's only humane to provide water. Various embodiments according to this invention may include a water bowl that is affixed to the trap so it can't be knocked over, a removable and/or refillable water bottle that attaches to the side of the trap with a drip feeder, or both.

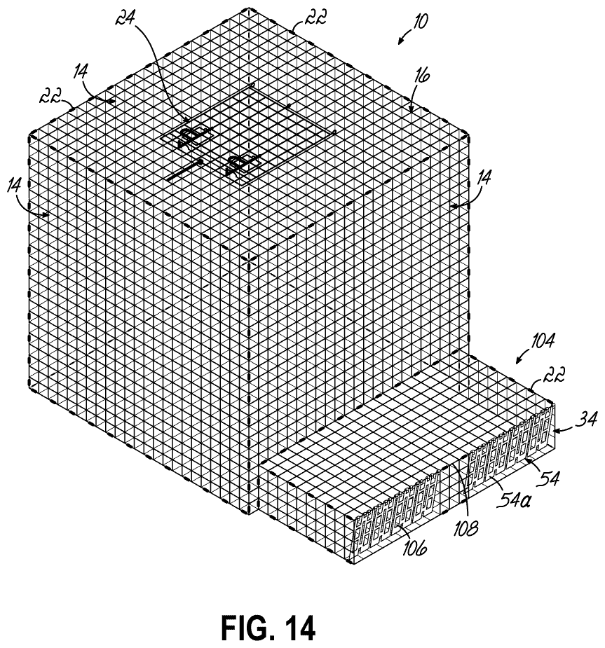

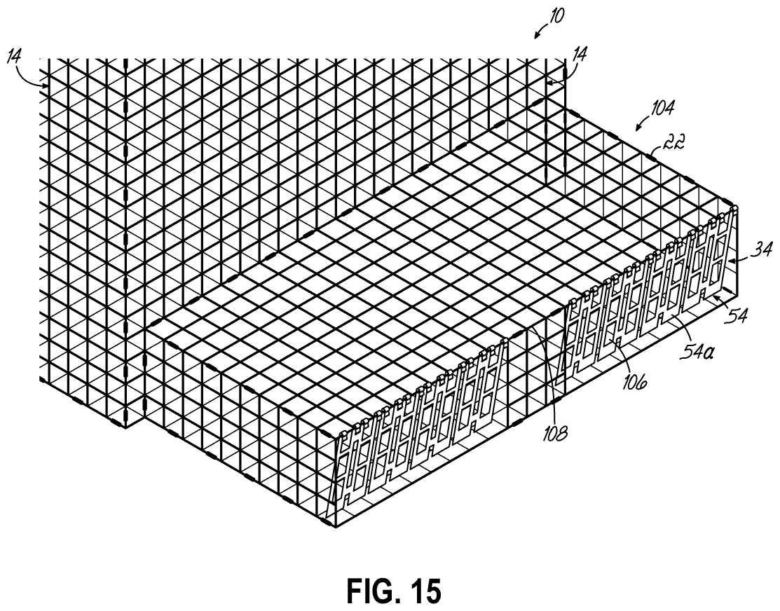

An alternative embodiment of the trap 10 according to this invention is shown in FIGS. 14-15 in which the confinement volume for the animal(s) 12 is defined by the trap 10 and is in communication with a chute 104 with the entry door 34 found in a free end of the chute 104. The chute 104 is in communication with the confinement volume of the trap 10. While the chut 104 and associated entry door 34 is located on one side of the trap 10, it will be understood by those of ordinary skill in the art that entry doors 34 and/or chutes 104 may be found on as many sides of the trap 10 as desired.

The tines 54 of the entry door 34 of the embodiment in FIG. 15 are formed in double width plates 54a with apertures 106 in each plate 54a. Each tine 54 is independently pivotal from the rest position shown in FIG. 15 relative to the other tines 54 in the entry door 34. Each tine 54 is pivotally mounted to an upper rung 108 at the free end of the chute 104 in this embodiment. Multiple entry doors 34 may be spaced apart from one another as shown in FIG. 15. The tines 54 of the trap 10 of FIGS. 14-15 when in the closed configuration as shown rest against a detent which prevents them from pivoting outwardly and allowing the captured animals from escaping the trap 10. The detent which prevents outward pivotal movement of the tines 54 may be the bottom of the chute 104 (FIG. 15) or another distinct obstruction or component of the trap 10. As is shown in FIGS. 14-15, the tines 54 when in the rest or closed position are not vertical but canted or inclined relative to the horizontal bottom of chute 104.

In various embodiments, the tines 54 are at about a 25 degree angle minimum facing in, for uneven ground. If the trap with doors on an uphill inclination, the tines 54 would hang open enough to allow for the animals to escape. With the tines 54 at the appropriate angel, the tines 54 create a “wedge” against the base of the trap 10 and don't require any component on the base to stop them from swing outwardly.

The tines 54 may act and pivot independently from each other, to conform to the shape or profile of the animal as they enter the trap 10 making to more difficult for the animal to reverse course or escape from the trap 10. The individual tines 54 according to various embodiments are removable for repair and/or replacement as needed.

In alternative embodiments of this invention, the side walls 14 may contain all the tines 54 which are attached directly to the mesh of the side walls 14 and are removable for repairs. The side walls 14 may connect directly to the base 28 which may be flat. The auxiliary cage 70 may have a similar construction. The auxiliary cage 70 may have a receiver for the chute/tunnel from the main trap 10, the water features, a locking door where the receiving chute enters so that when the auxiliary cage 70 is removed from the trap 10, the doors closes and locks to stop the animals from escaping and then a locking access door on top.

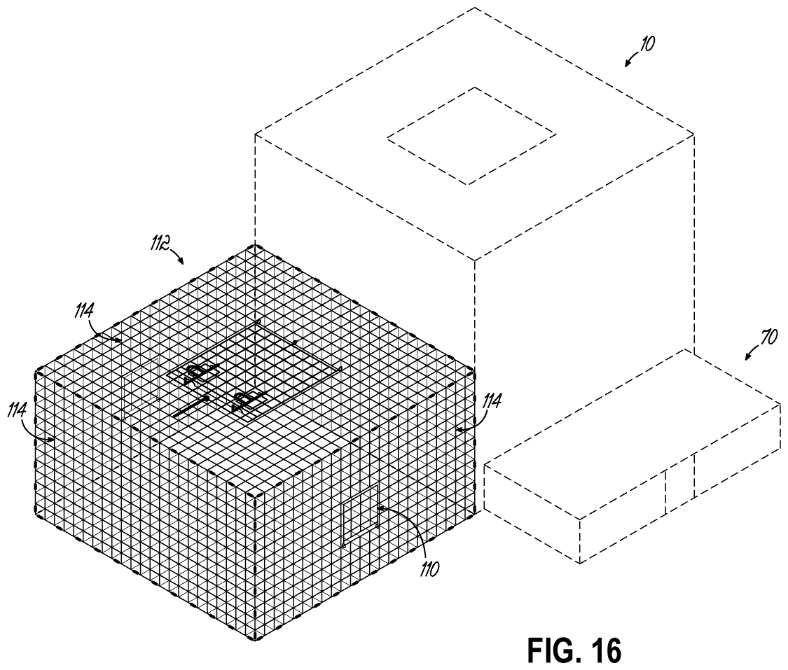

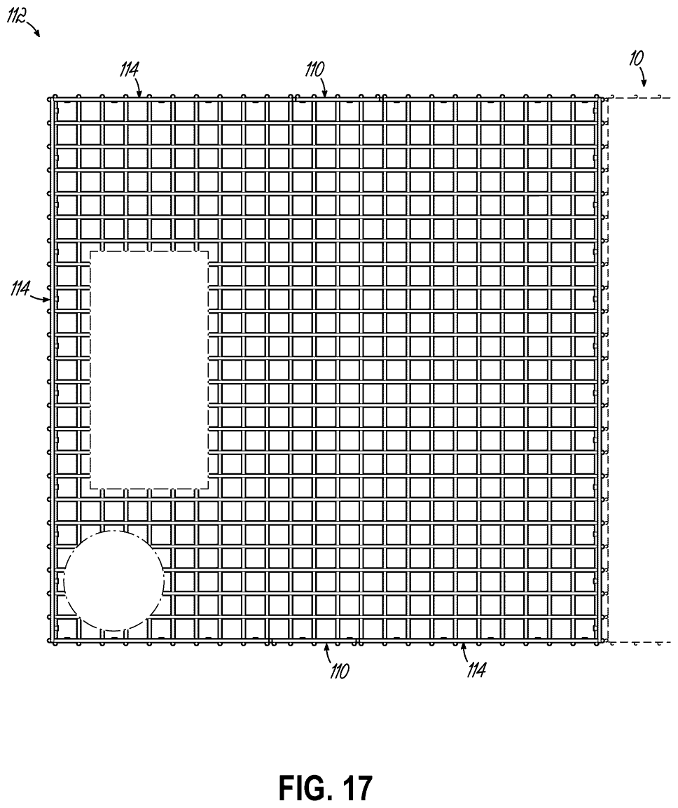

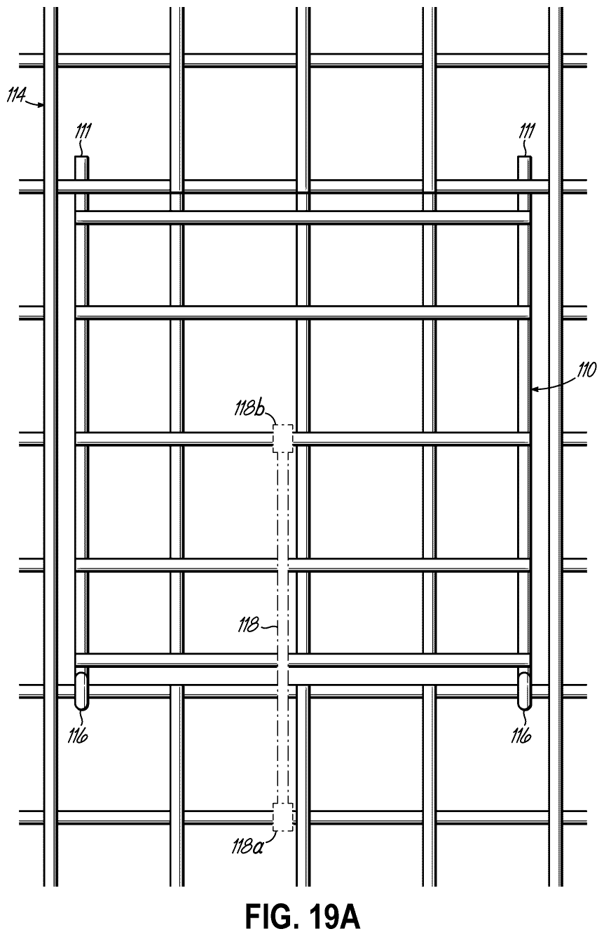

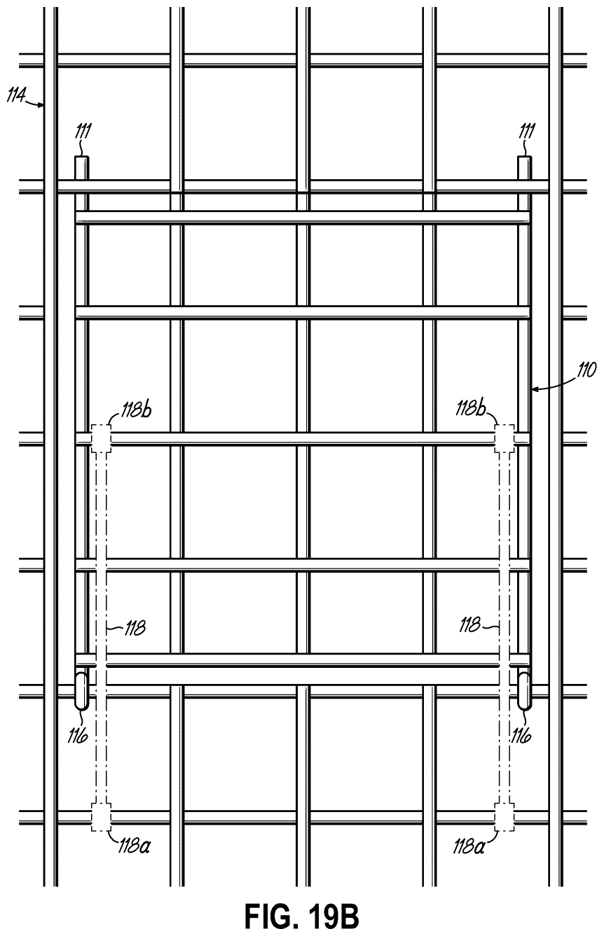

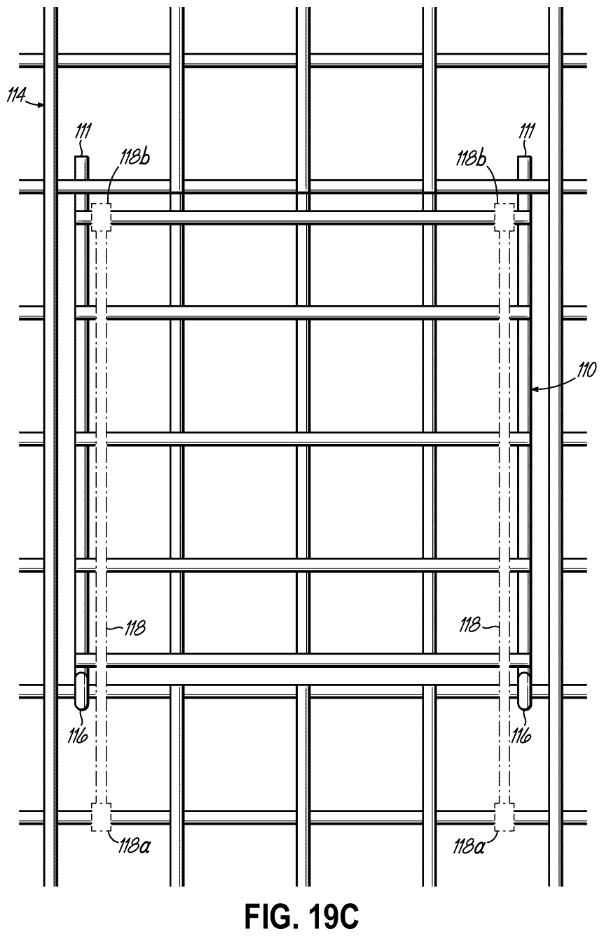

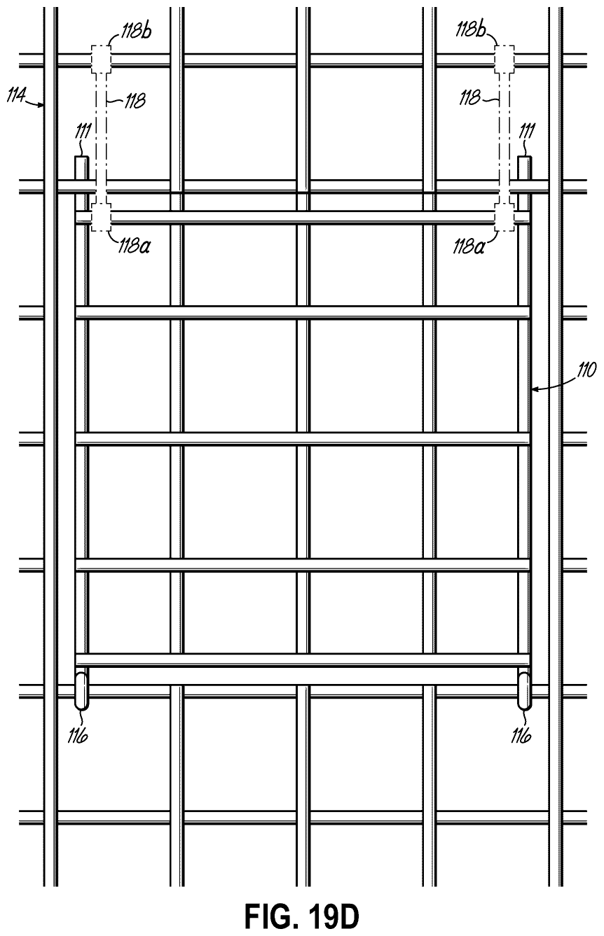

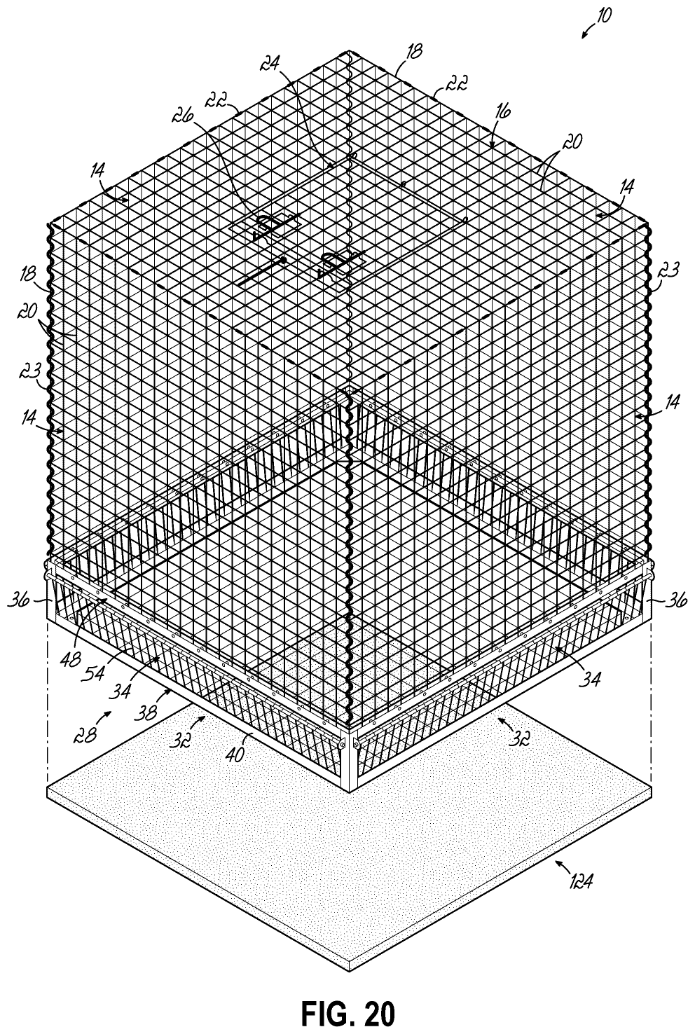

Still further embodiments of the trap 10 according to this invention are shown in FIGS. 16-20. The embodiments of FIGS. 19-20 include features which allow for non-targeted animals or species which enter the trap 10 to escape while containing the target animals and species in the trap 10. The trap 10 of various embodiments of this invention is specific to targeting reptiles that are omnivores and carnivores. However, non-targeted animals or species may become captured in the trap and various embodiments of this invention allow for such non-targeted animals such as fur bearing, non-target animals to escape the trap 10. Such features further increase the likelihood that any fur bearing, non-target animal will escape, which is important for wide spread adoption and usage of the trap 10. Such features may be incorporated into the trap 10 because of bait changes necessary to attract target animals that will also increase interest from non-target or fur bearing animals and the likelihood that they will go deeper in to the trap. It has been observed that fur bearing animals (i.e., raccoons, foxes, opossums, etc.) once they realize they are trapped will begin pulling on the sides of the trap. On the other hand, reptiles, especially snakes, will start pushing on the sides of the trap.

FIGS. 16-19D show various embodiments of an escape door 110 included in a portion of the trap 10. The escape door 110 may be incorporated into any wall 14, 16 of the main trap 10 or any wall or top of a holding chamber 112 in communication with the main trap 10 and/or the auxiliary cage 70. The escape door 110 may be added to the holding chamber 112 of the trap 10 according to various embodiments and configurations.

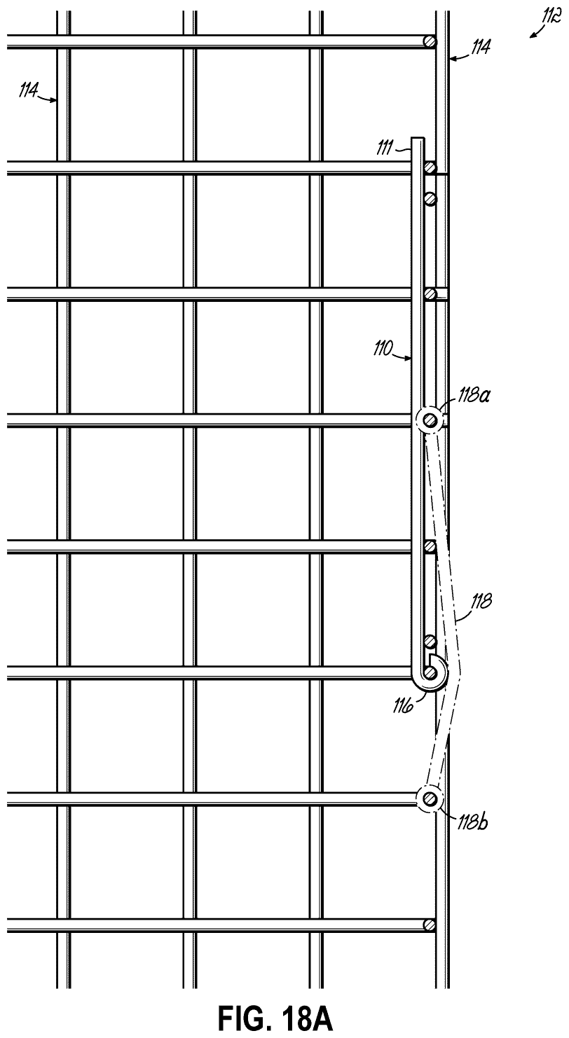

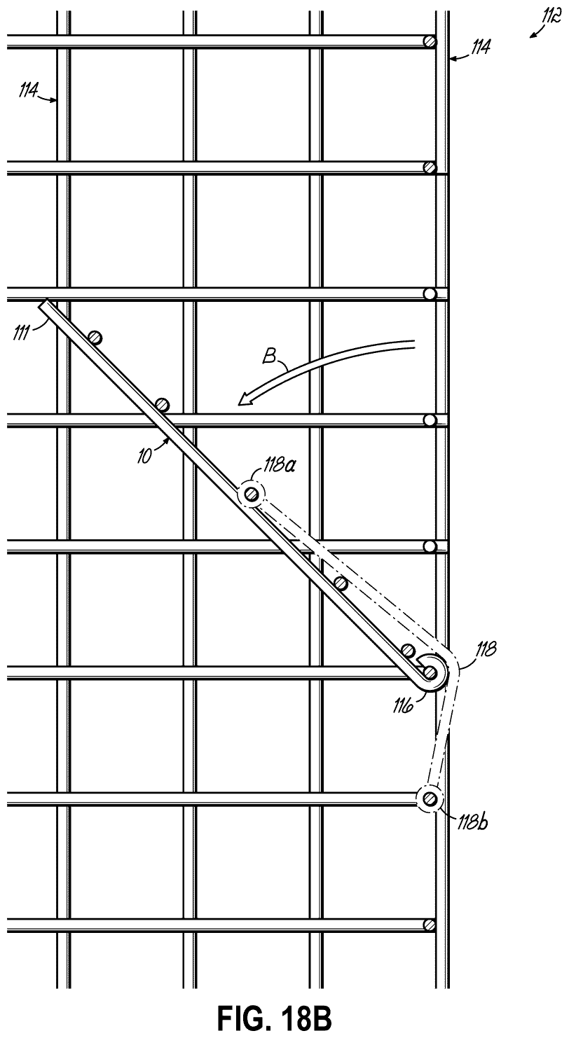

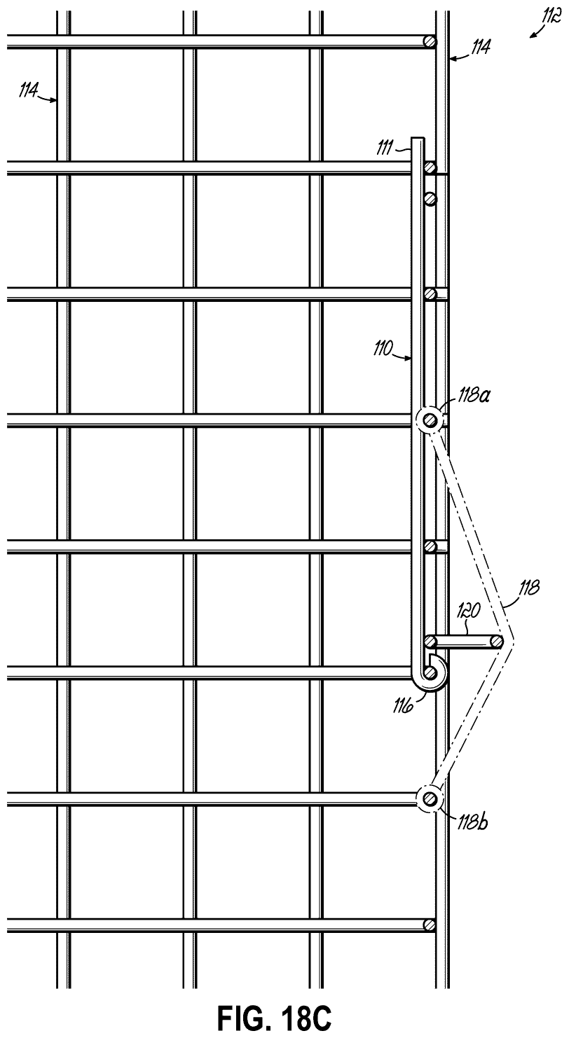

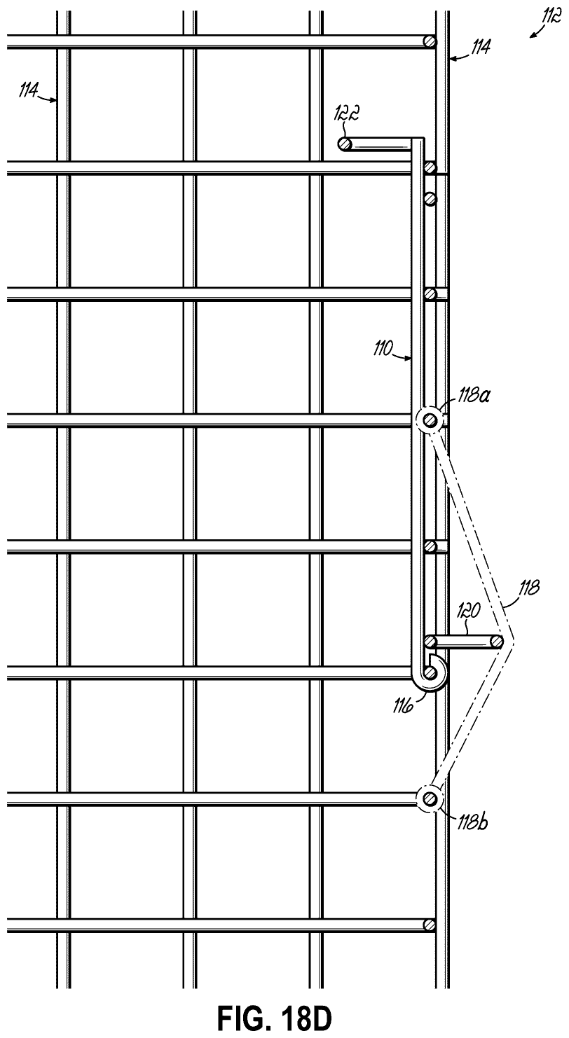

The escape door 110 may be a simple, flat member that will only open inwardly, one example is shown in FIG. 16 with the escape door on a side wall 114 of the holding chamber 112. The escape door 110 may include a stop 111 projecting upwardly from a distal end of the door 110 opposite a pivotal connection 116. The door 110 may be located on any portion of the trap 10 or the holding chamber 112, including the side wall and/or top wall. One end of the door 110 is coupled to the side wall 114 by a pivotal connection 116. The door 110 may be biased into a closed configuration generally flush with the remainder of the side wall 114 when the stop 111 contacts the side wall 114 as shown in FIG. 16 by a biasing member 118 such as a spring, elastic member or bungee cord. One end 118a of the biasing member 118 may be secured to the escape door 110 and the opposite end 118b may be secured to an adjacent portion of the side wall 114. As the non-targeted or fur bearing animal captured in the holding chamber 112 is searching for an exit to escape, they will eventually come across this escape door 110 and when they pull on the escape door 110 from inside the chamber 112, the door 110 will pull open, arrow B, by stretching the biasing member 118, providing an exit, and the escape door 110 will snap close by the tension provided by the biasing member 118 as the non-target animal exits the chamber 112. In the embodiment of FIG. 18A, the end 118a of the biasing member 118 is connected to the middle region of the escape door 110. In the embodiment of FIG. 18C, the escape door 110 includes an extension member 120 extending perpendicularly from the middle region of the outer face of the escape door 110 with the biasing member 118 traversing over a distal end of the extension member 120. This arrangement creates more leverage and tension on the door 110 to make it harder to open requiring more force to open.

In the embodiment shown in FIG. 18D, a handle 122 is added to the escape door 110. The handle 122 extends perpendicularly from an inner face of the door 110 at the free end of the door opposite from the pivotal connection 116 of the door 110 to the remainder of the trap 10. The handle 122 provides easier manipulation and opening of the door 110 for a non-targeted animal to open the door 110 and escape the trap 10 or holding chamber 112 as the case may be. The handle 122 provides the fur bearing trapped animal with something additional to grab on to and more leverage to get the door 110 open.

The biasing member 118 according to various embodiments of this invention may be located and/or attached to different locations on the door 110 itself and/or the trap 10 or holding chamber 112. For example, with end 118a attached to the side wall 114 proximate the pivotal connection 116, the end 118b of the biasing member may attached to the center of the door 110 (see FIG. 19A), it may be attached to the sides of the door 110 (see FIG. 19B) or it may be attached to the top of the door 110 (see FIG. 19C) and attach to the top of the door. Alternatively, the end 118b of the pivotal connection 118 may be attached to the trap 10 or holding chamber proximate the free end of the door 110 and the end 118a attached to the free end of the door 110 (see FIG. 19D).

A further feature of embodiments of this invention is shown in FIG. 20 is a thermal base 124 underneath the trap 10. The thermal base 124 may be integral to the trap 10 or an underlayment on which the trap 10 is supported. The base 124 may be a polymer or styrene composition that is black and absorbs heat from the daytime sun and provides a heat source at night. A black or dark color absorbs the heat and a thicker the base 124 will have greater thermal retention capability. Many of the target reptiles/snakes are nocturnal and are attracted to heat on cool nights. The rodents for bait are also nocturnal. The additional heat source will only help attract both, bait and target animals.

In alternative embodiments, the base 124 may have a direct heat source, such as one or more candle, a heat source such as that used in pocket/hand warmers or a camping/tent heater. A solar panel, battery, photocell/timer, heat source could also be included. The heat could come from a heat lamp or a radiant source, like heated rocks. Such additional heating sources could be located in any chamber of the trap 10. This would allow the trap 10 to be located just about anywhere and provide a heat source for these target reptiles. It is not uncommon to for these target reptiles/snakes to lay at night on roads heated by the sun during the daytime in an attempt to stay warm. During cool nights and winter months this feature could be more attractive to the target animals than actual bait.

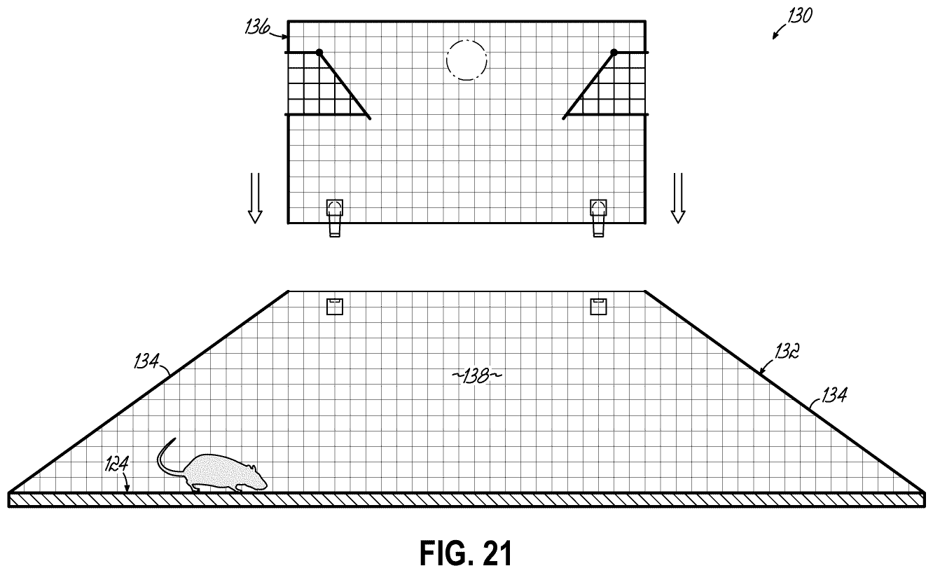

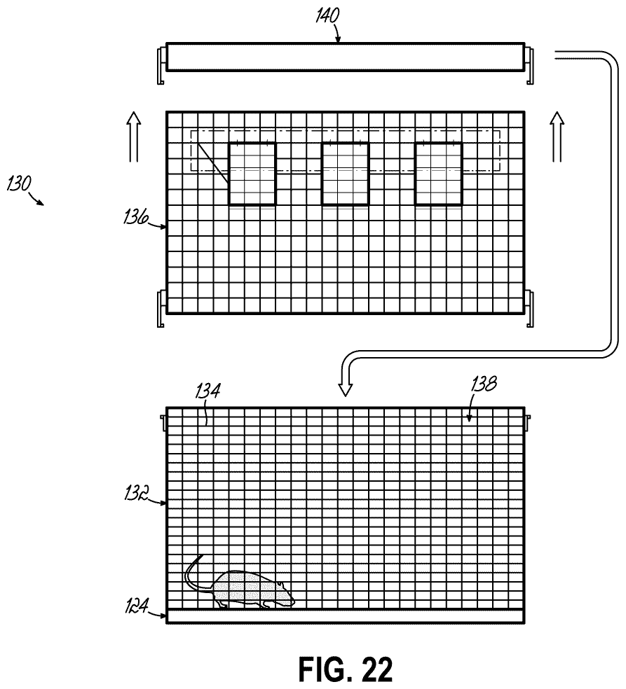

Further alternative embodiments of this invention are shown in FIGS. 21 through 25D which are generally directed to a bait trap feature which may be a stand-alone trap or used in conjunction with the trap 10 for a self-baiting trap feature. In certain embodiments, the bait trap assembly 130 is directed to a rat only trap using the top portion (mechanicals) of the trap 10. Historically, (for the last 30 years) commercially speaking, rats have been poisoned using “bait stations” where the rat passes thought the bait station smells the poison and consumes a dose of poison that will kill it in the rear future. Issues with such bait stations include (1) over the years, the rats that didn't consume a lethal dose began to build immunity to the poison; (2) the dose of poison cannot be increased as it will have a negative effect on the food chain, as the dead rats can be consumed by other animals (cats, foxes, raccoons, etc.) and thus risk killing them also. It has been observed that the rat populations are exploding.

One solution to this situation is to live trap the rats and exterminate them in a controlled setting. The conventional spring loaded rat kill traps are not realistic for large scale use. Rats need to be caught in bulk for effective management. The rat trap assembly 130 (see FIGS. 21-23) builds off the design of the rat trap add-on for the animal trap 10 and may be used as a stand-alone trap or in combination with the animal trap 10. Simply put, the trat trap assembly includes a base 132. The base 132 is much larger and sloped to provide a gradual ramp to the entrance(s) 134 of the trap assembly 130. Most bait stations are designed to sit close to the buildings and walls because rodents like to have their whiskers touching the something such as the building walls as they are move about in solitude because the tactile whisker sensation makes them feel safer. One aspect of the rat trap assembly 130 in various embodiments is the ramped base 132 at each end so it will work from either direction while sitting against a wall so the rat continues to feel safe.

As the rat approaches the trap assembly 130 it will smell the bait to further attract them. The top portion 136 of the assembly 130 is fully removable and is securely fastened to a trapping chamber 138 when in use so other predators can't get in or open the trap assembly 130. The trapping chamber 138 may be staked, weighted, or otherwise secured as well. The trapping chamber 138 may hold hundreds of rats. When it is time to process or empty the trap assembly 130, the top portion or mechanicals 136 are removed and a special lid 140 is installed and locked in place. Rat's carry all kinds of diseases. A user or caretaker for the trap assembly 130 should avoid handling the captured rats as much as possible. The lid 140 on the trap assembly 130 is designed to allow the euthanasia process to take place while the rats are in the trapping chamber 138. Once euthanized, the rats may be dumped into a container suitable for incineration. The trapping chamber 138 may be sanitized and placed back in service. It is envisioned this trap assembly 130 may be used in cities and towns everywhere. It can be installed just about anywhere, for example by dumpsters, building, gardens, etc.

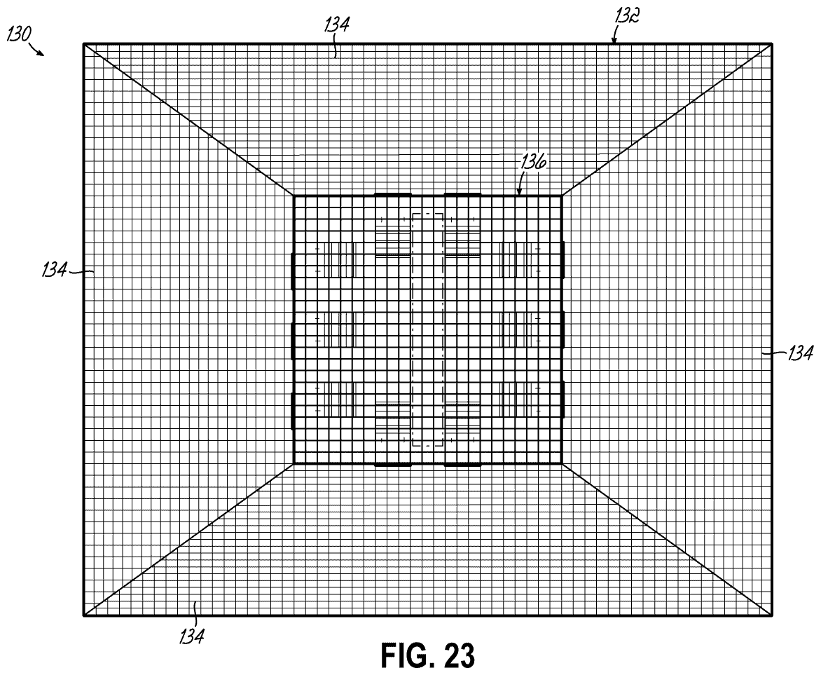

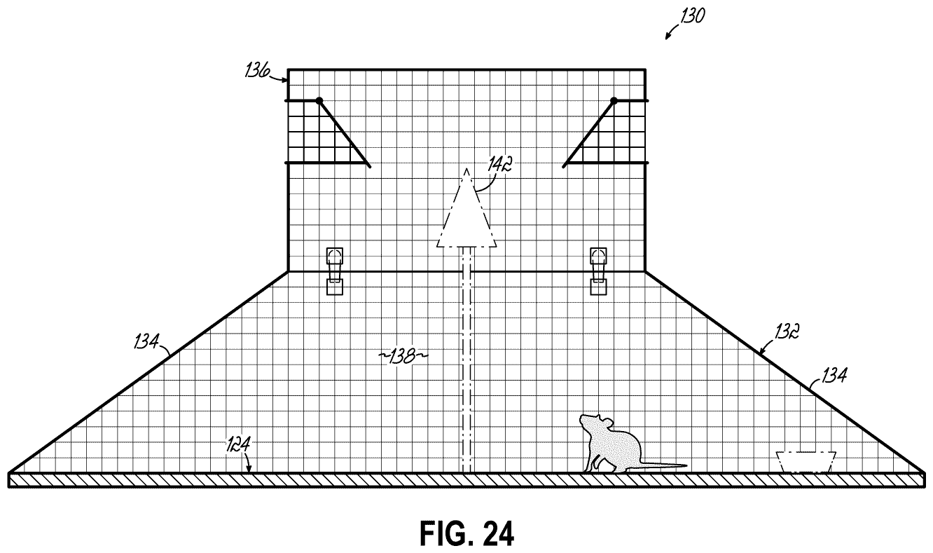

The trap assembly 130 can be enlarged to provide access from all four sides (see FIGS. 23-24). In this case, a detachable bait cone 142 may be positioned in the center of the assembly 130. The bait cone 142 is an upside down funnel with bait in the center thereof. The rat will jump to get to the bait only to slide down into the interior of the cone 142 and in to the trapping chamber 138. The cone 142 may project upwardly from the bottom of the trapping chamber 138 and be removable where the trap assembly 130 is being processed, cleaned, replaced, etc. The trap assembly 130 may be used in combination with the trap 10 to create a self-baiting trap to bait for pythons or other target animals. The inventors are not aware of another trap designed to capture one animal (i.e., rats with the trap assembly 130) to be used as bait for another animal (i.e., pythons in the trap 10) all in the same trap complex.

The trap assembly 130 could be attached/mounted inside the auxiliary cage 70 of the trap 10 and is designed to capture dozens of rats and be durable enough to withstand the efforts of the pythons or other invasive species to get to the rats to eat them. The larger the heat signature coming from the trap will only extend the reach of the trap and attract more. Top portion 138 of the rat trap assembly 130 could be made of solid material so that the rats can't climb into the bait and entrance portion of the trap 130 and to support these components. The bottom portion 132 of the trap assembly 130 may be constructed of screen, perforated metal, or wire mesh to allow for the noise, scent, and heat to radiate outward. The entrance 136 may be a tube or pipe with a one-way angled door at the end, so as the rat pushes through the door it will close behind them and they can only move forward. The bait will be in a free spinning perforated/screen tube extending across the top of the trap 130. The bait placement is designed to get the scent of the rat bait in the air, like peanuts. But the tube will not allow the rats access to eat the bait.

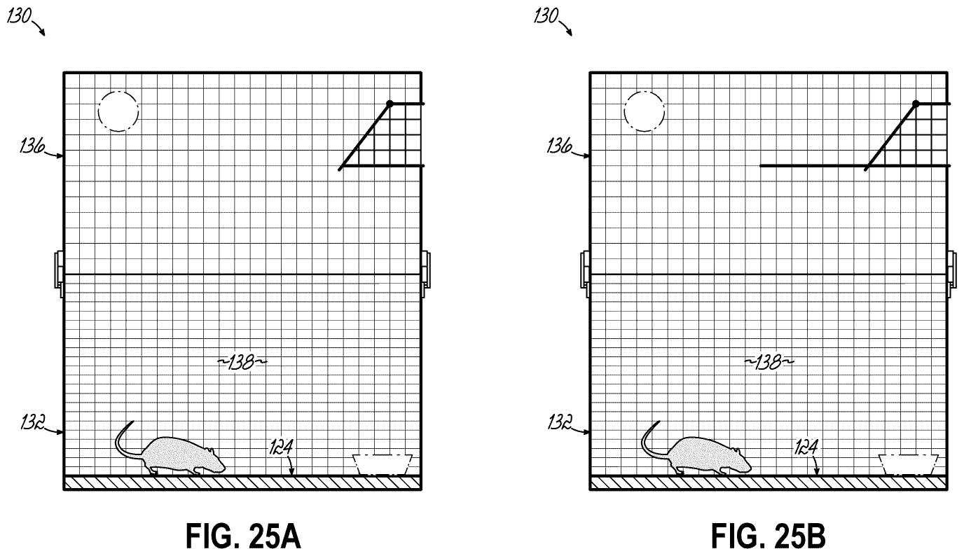

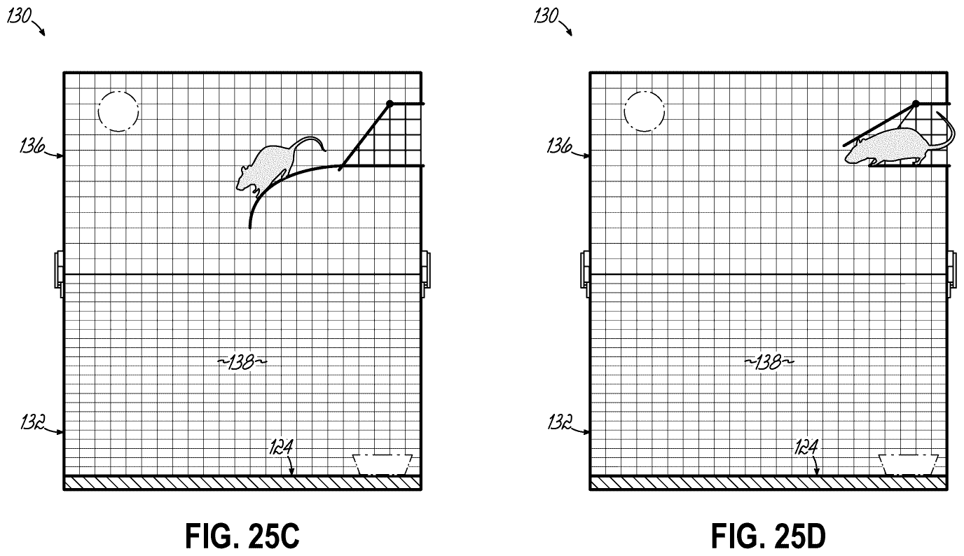

FIG. 25A shows a first option which allows the rats to jump to the bait and thus fall off because the structure supporting the rats spins. A second option is shown in FIG. 25B which includes a small plank for the rats to perch on while they decide what they want to do, but the door has closed behind them to capture them in the trap assembly 130. FIG. 25C shows another option which includes a slide that extends across all entrances so that as the rats step out on the slide to reach the bait, the slide gets stepper until they can no longer hold traction. The trap assembly 130 may include multiple entrance tubes. Further, a water bowl may be provided in the bottom for humane treatment of the trapped rats. A lid/top is provided on the trap assembly 130 to provide access to the bait and captured rats.

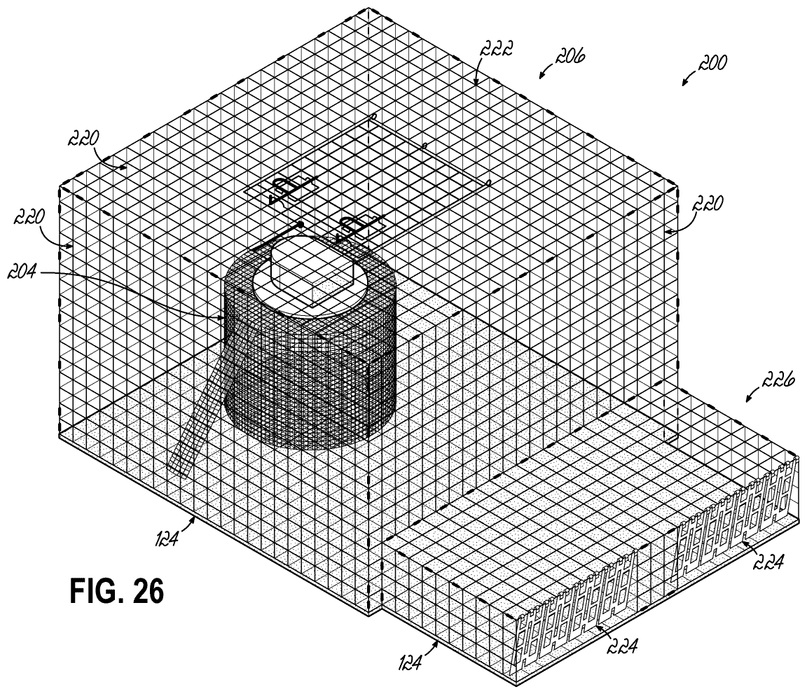

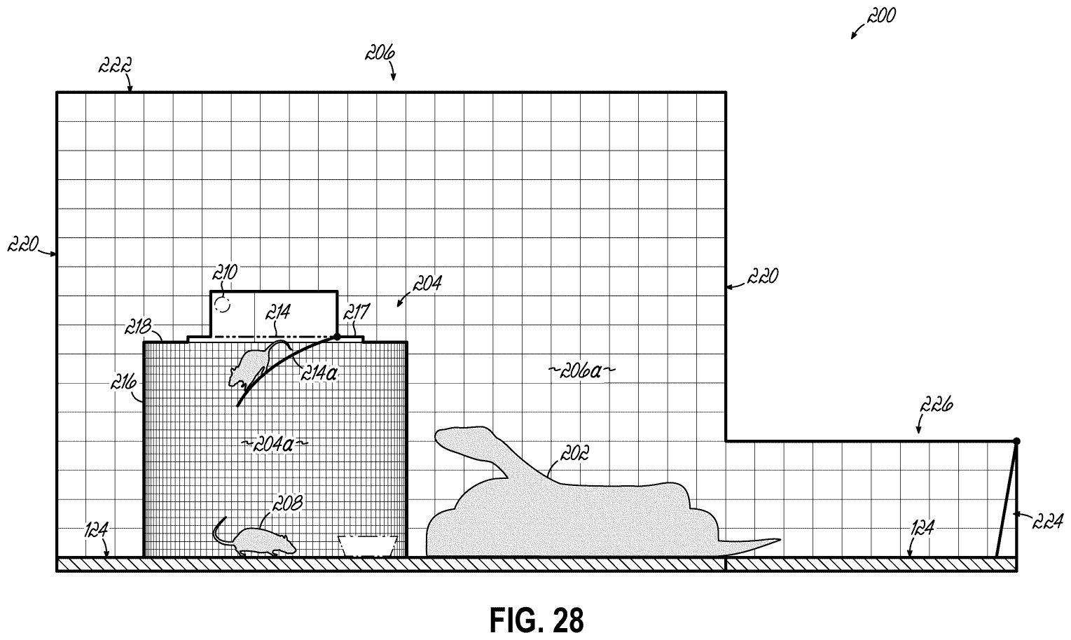

Referring to FIGS. 26-28, another embodiment of an animal trap 200 according to this invention is shown for capturing nuisance animals, and more particularly, python snakes 202 (FIG. 28). According to this embodiment, a first inner trap 204 is located within a second outer trap 206. The trap 200 is a live trap and does not harm the animals captured therein. Specifically, according to this embodiment, the inner trap 204 attracts bait animals 208 such as rats, mice and the like while the outer trap 206 captures the target animal such as python snakes 202. The bait animal 208 cannot be harmed by the target animal 202 while the bait animal 208 is within the inner trap 204. Both traps 204, 206 can be either a single capture (one of each animal) or a multiple capture where the respective trap 204, 206 can catch several of each animal 208, 202, or a single bait animal 208 can attract multiple target animals 202. The inner first trap 204 can be reconfigured as necessary based on the type and size of bait animal 208 being targeted.

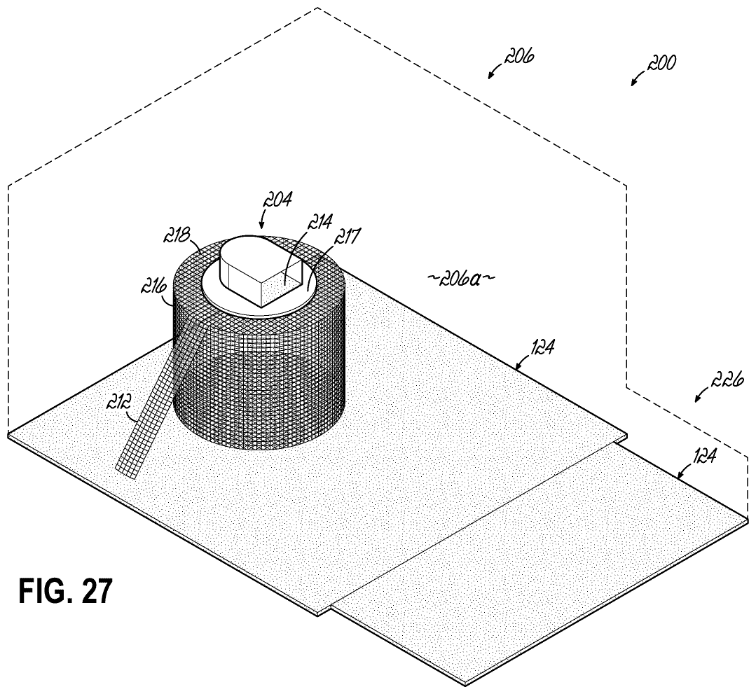

The inner and outer traps 204, 206 may be of any size and configuration within the scope of this invention. The inner trap 204 defines an inner trap containment volume 204a and the outer trap 206 defines an outer trap containment volume 206a. As seen best in FIGS. 26-27, in one embodiment the inner trap 204 has a cylindrical sidewall 216, a generally circular top wall 218 and a trap door 214 on the top wall 218 for one way entry of the target animals 208 for the inner trap 204 such as rats, mice, rodents and other animals. A ramp 212 or other structure may assist the target animals 208 in reaching the trap door 214 for entry into the trap 204. The outer trap 206 may have a cuboid shape with one or more side walls 220 and a top wall 222. A one-way entry door 224 may be provided in one or more sections to allow for entry, but not exit, of the animals 208, 202 into the outer trap containment volume 206a. The one-way entry door 224 may be of a design as previously disclosed in other embodiments of this invention or of another design. The outer trap 206 may include an entry portal section in the form of a chute 226 which is in communication with the containment volume 206a of the trap 206. While the chute 226 and associated entry door 224 are located on one side of the trap 206, it will be understood by those of ordinary skill in the art that entry doors 224 and/or chutes 226 may be found on as many sides of the trap 206 as desired. In various embodiments of this invention, the inner trap 204 is entirely located within the containment volume 206a of the outer trap 206.

In one mode of operation, rat bait 210 may be placed in the bottom/center of the inner trap 204 which will attract the target animals 208, in one case rats. The rats 208 will naturally look for a way into the outer trap 206 and ultimately the inner trap 204 to get to the bait 210. The rats 208 can scale the sides of the wire mesh cylinder or climb the sides of the trap 204 or use a ramp 212 to access the top of the inner trap 204. From the top of the trap 204, the rats 208 will fall into the interior volume 204a of the trap 204 via a trap door 214 and associated slide 214a. A solid lid 216 is provided on the trap 204 so the rats 208 can't climb to the top of the trap 204 to try to escape. The live bait animals 208 in the inner trap 204 may be rats, rodents, etc. become bait for the ultimate target animal 202. The more rats 208 that are trapped in the inner trap 204, the better. The rats 208 in the inner trap 204 attract the pythons 202 into the containment volume 206a of the outer trap 206 via the one-way door 224. Once in the outer trap 206, the pythons 202 cannot access or eat the rats 208 in the inner trap 204 nor can the pythons 202 escape the containment volume 206a of the outer trap 206 because the entry door does 224 not open from the containment volume 206a.

The trap 200 of this embodiment may include a thermal base 124 underneath the trap 200. The thermal base 124 may be integral to the trap 200 or an underlayment on which the trap 200 is supported. The base 124 may be a polymer or styrene composition that is black and absorbs heat from the daytime sun and provides a heat source at night. A black or dark color absorbs the heat and a thicker the base 124 will have greater thermal retention capability. Many of the target reptiles/snakes 202 are nocturnal and are attracted to heat on cool nights. The rodents 208 for bait are also nocturnal. The additional heat source will only help attract both, bait and target animals 208, 202.

While this invention has been described in conjunction with a number of embodiments, those skilled in the art will recognize that certain modifications to the described embodiments still fall within the spirit and scope of the invention. Accordingly, the scope of this invention is not meant to be limited by the disclosure herein, but may be modified while maintaining its novel process and construction, as would be apparent to one of ordinary skill in the art.

1. A trap for a target animal, the trap comprising:
a first inner trap defining a first inner trap containment volume adapted to contain a bait animal therein;
a second outer trap defining a second outer trap containment volume adapted to contain the target animal therein;
a one-way entry door in the second outer trap allowing for entry of the bait animal and the target animal therethrough and into the second outer trap containment volume and inhibit exit from the second outer trap containment volume once therein;
a door on the first inner trap allowing for entry of the bait animal into the first inner trap containment volume while inhibiting entry of the target animal into the first inner trap containment volume;
wherein the bait animal being confined in the first inner trap containment volume attracts the target animal to enter the second outer trap containment volume via the one-way entry door and thereby trap the target animal in the trap.

2. The trap of claim 1 wherein the first inner trap is located within the second outer trap containment volume.

3. The trap of claim 1 wherein the one-way entry door is divided into a plurality of one-way entry door segments.

4. The trap of claim 1 wherein the one-way entry door further comprises:
a plurality of downwardly oriented spaced tines.

5. The trap of claim 4 wherein each of the plurality of downwardly oriented tines is pivotally mounted about an axis spaced from the ground surface for independent pivotal movement relative to each other.

6. The trap of claim 4 wherein each of the plurality of downwardly oriented spaced tines is juxtaposed against a detent confronting the confinement volume.

7. The trap of claim 1 wherein the first inner trap has a generally cylindrical shape.

8. The trap of claim 1 wherein the door is located on a top portion of the first inner trap.

9. The trap of claim 8 further comprising:
a ramp to provide the bait animal access to the door.

10. The trap of claim 1 wherein the first inner trap has a shape different from a shape of the second outer trap.

11. The trap of claim 1 wherein the second outer trap has a generally cuboid shape.

12. The trap of claim 1 further comprising:
bait within the first inner trap containment volume to attract the bait animal thereto.

13. A trap for a target animal, the trap comprising:
a first inner trap having a generally cylindrical shape and defining a first inner trap containment volume adapted to contain a bait animal therein;
a second outer trap having a generally cuboid shape defining a second outer trap containment volume adapted to contain the target animal therein;
a one-way entry door in the second outer trap allowing for entry of the bait animal and the target animal therethrough and into the second outer trap containment volume and inhibit exit from the second outer trap containment volume once therein;
a door on the first inner trap located on a top portion of the first inner trap allowing for entry of the bait animal into the first inner trap containment volume while inhibiting entry of the target animal into the first inner trap containment volume;
wherein the bait animal being confined in the first inner trap containment volume attracts the target animal to enter the second outer trap containment volume via the one-way entry door and thereby trap the target animal in the trap;
wherein the first inner trap is located within the second outer trap containment volume.

14. The trap of claim 13 wherein the one-way entry door is divided into a plurality of one-way entry door segments.

15. The trap of claim 13 wherein the one-way entry door further comprises:
a plurality of downwardly oriented spaced tines pivotally mounted about an axis spaced from the ground surface for independent pivotal movement relative to each other and each of the plurality of downwardly oriented spaced tines is juxtaposed against a detent.

16. The trap of claim 13 further comprising:
a ramp to provide the bait animal access to the door.

17. The trap of claim 13 further comprising:
bait within the first inner trap containment volume to attract the bait animal thereto.

18. An animal trap comprising:
at least one wall which at least in part defines a containment volume of the trap;
a one-way entry door in the trap allowing for entry of the animal therethrough and into the containment volume and inhibit exit from the containment volume once therein;
an escape door in the trap for allowing egress of a non-target animal in the containment volume from the containment volume, the escape door inhibiting egress of a target animal in the containment volume when in the containment volume.

19. The animal trap of claim 18 further comprising:
a biasing member coupled to the escape door biasing the escape door toward a closed position.

20. The animal trap of claim 18 further comprising:
a handle accessible to the non-target animal for movement of the escape door from a closed position toward an open position for egress from the containment volume.
